(19) United States
(12) Patent Application Publication
(10) Pub. No.: US 2025/0016675 A1
(43) Pub. Date: Jan. 9, 2025

(54) FIRST NODE, SECOND NODE, AND METHODS PERFORMED THEREBY, FOR HANDLING A RECEIVER AT A WIRELESS DEVICE

(71) Applicant: Telefonaktiebolaget LM Ericsson (publ), Stockholm (SE)

(72) Inventor: Andreas HÖGLUND, Solna (SE)

(21) Appl. No.: 18/712,362

(22) PCT Filed: Nov. 25, 2022
(86) PCT No.: PCT/SE2022/051104

§ 371 Date: May 22, 2024

Related U.S. Application Data
(60) Provisional application No. 63/264,589, filed on Nov. 26, 2021.

(51) Int. Cl. H04W 52/02

(52) U.S. Cl. CPC H04W 52/0229

(57) ABSTRACT

A method by a first node (101), for handling a receiver at a wireless device (130). The first node (101) and the wireless device (130) operate in a wireless communications network (100). The first node (101) determines (502) whether or not a condition is met. The condition is a measurement of a signal received by the wireless device (130) being above or below a first threshold. The first node (101) initiates (503), based on a result of the determining (502), a procedure to wake-up the wireless device (130). The first node (101) initiates the procedure by applying at least one of: a downlink signal to be used, and a receiver to receive the downlink signal to wake-up the wireless device (130) at the wireless device (130).

### TECHNICAL FIELD

The present disclosure relates generally to a first node, and methods performed thereby, for handling a receiver at a wireless device. The present disclosure also relates generally to a second node and methods performed thereby for handling the receiver at the wireless device.

### BACKGROUND

Nodes within a communications network may be wireless devices such as e.g., User Equipments (UEs), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone, and/or between a wireless device and a server via a Radio Access Network (RAN), and possibly one or more core networks, comprised within the communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

Nodes may also be network nodes, such as radio network nodes, e.g., Transmission Points (TP). The communications network covers a geographical area which may be divided into cell areas, each cell area being served by a network node such as a Base Station (BS), e.g. a Radio Base Station (RBS), which sometimes may be referred to as e.g., gNB, evolved Node B (“eNB”), “eNodeB”, “NodeB”, “B node”, or Base Transceiver Station (BTS), depending on the technology and terminology used. The base stations may be of different classes such as e.g. Wide Area Base Stations, Medium Range Base Stations, Local Area Base Stations and Home Base Stations, based on transmission power and thereby also cell size. A cell is the geographical area where radio coverage is provided by the base station at a base station site. One base station, situated on the base station site, may serve one or several cells. Further, each base station may support one or several communication technologies. The communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The so-called 5G system, from a radio perspective started to be standardized in 3GPP, and the so-called New Radio (NR) is the name for the radio interface. NR architecture is being discussed in 3GPP. In the current concept, gNB denotes an NR BS, where one NR BS may correspond to one or more transmission/reception points. The expression Uplink (UL) may be used for the transmission path in the opposite direction i.e., from the wireless device to the base station.

The Fifth Generation (5G) Packet Core Network may be referred to as Next Generation (NG) Core Network, abbreviated as NG-CN, NGC or 5G CN.

### Internet of Things (IoT)

The Internet of Things (IoT) may be understood as an internetworking of communication devices, e.g., physical devices, vehicles, which may also be referred to as “connected devices” and “smart devices”, buildings and other items-embedded with electronics, software, sensors, actuators, and network connectivity that may enable these objects to collect and exchange data. The IoT may allow objects to be sensed and/or controlled remotely across an existing network infrastructure.

“Things,” in the IoT sense, may refer to a wide variety of devices such as heart monitoring implants, biochip transponders on farm animals, electric clams in coastal waters, automobiles with built-in sensors, DNA analysis devices for environmental/food/pathogen monitoring, or field operation devices that may assist firefighters in search and rescue operations, home automation devices such as the control and automation of lighting, heating, e.g., a “smart” thermostat, ventilation, air conditioning, and appliances such as washer, dryers, ovens, refrigerators or freezers that may use telecommunications for remote monitoring. These devices may collect data with the help of various existing technologies and then autonomously flow the data between other devices.

It is expected that in a near future, the population of IoT devices will be very large. Various predictions exist, among which one assumes that there will be >60000 devices per square kilometer, and another assumes that there will be 1000000 devices per square kilometer. A large fraction of these devices is expected to be stationary, e.g., gas and electricity meters, vending machines, etc.

### Machine Type Communication (MTC)

Machine Type Communication (MTC) has in recent years, especially in the context of the Internet of Things (IoT), shown to be a growing segment for cellular technologies. An MTC device may be a communication device, typically a wireless communication device or simply user equipment, that is a self and/or automatically controlled unattended machine and that is typically not associated with an active human user in order to generate data traffic. An MTC device may be typically simpler, and typically associated with a more specific application or purpose, than, and in contrast to, a conventional mobile phone or smart phone. MTC involves communication in a wireless communication network to and/or from MTC devices, which communication typically may be of quite different nature and with other requirements than communication associated with e.g. conventional mobile phones and smart phones. In the context of and growth of the IoT, it is evident that MTC traffic will be increasing and thus needs to be increasingly supported in wireless communication systems.

Wake-up receiver (WUR), sometimes also referred to as ‘wake-up radio’, may be understood to relate to enabling a low power receiver in UEs, which, in case of the detection of a ‘Wake-up signal’ (WUS), may wake up the main, e.g., baseband/higher power, receiver to detect an incoming message, typically paging, e.g., the Physical Downlink Control Channel (PDCCH) in paging occasions (POs), scheduling the paging message on the Physical Downlink Shared Channel (PDSCH). The main benefit may be understood to be lower energy consumption and longer device battery life, or at a fixed energy consumption, the downlink latency may be reduced, shorter Discontinued Reception (DRX)/duty-cycles, and more frequent checks for incoming transmissions.

FIG. 1 is a schematic diagram illustrating location of a WUS and the paging occasion to which it is associated. In FIG. 1, white blocks indicate possible WUS, and PO positions, whereas the black boxes indicate actual WUS and PO positions.

### WUS for NB-IoT and LTE-M

### Release 15

In Rel-15, WUS was specified for NarrowBand IoT (NB-IoT) and Long Term Evolution for Machines (LTE-M). The main motivation was UE energy consumption reduction since, with the coverage enhancement, PDCCH may be repeated very many times and the WUS may be relatively much shorter and hence may require less reception time for the UE. The logic may be understood to be that a UE may check for a WUS a certain time before its PO, and only if a WUS is detected, the UE may continue to check for PDCCH in the PO, and if not, which is most of the time, the UE may go back to a sleep state to conserve energy. Due to the coverage enhancements, the WUS may be of variable length depending on the coverage of the UE, see FIG. 2.

FIG. 2 is a schematic diagram illustrating WUS for NB-IoT and LTE-M. As depicted in in FIG. 2, where the horizontal axis represents time, the WUS may have a duration, which may be a fraction of a configured maximum WUS duration. Between the end of the configured maximum WUS duration and the beginning of the associated paging occasion (PO) there may be a gap. A gap may be understood as a time offset between the WUS monitoring occasion and the paging occasion. A gap may also be referred to as an offset.

A WUS may be based on the transmission of a short signal that may indicate to the UE that it may need to continue to decode the Downlink (DL) control channel e.g., the full Narrowband PDCCH (NPDCCH) for NB-IoT. If such signal is absent, e.g., in Discontinuous Transmission (DTX) that is, if the UE does not detect it, then the UE may go back to sleep without decoding the DL control channel. The decoding time for a WUS may be considerably shorter than that of the full NPDCCH since it may only need to contain one bit of information, whereas the NPDCCH may contain up to 35 bits of information. This, in turn, may be understood to reduce UE power consumption and lead to longer UE battery life. The WUS would be transmitted only when there may be paging for the UE. But if there is no paging for the UE, then the WUS may be understood to not be transmitted, implying a discontinuous transmission (DTX) and the UE may go back to sleep e.g., upon detecting DTX instead of WUS. This is illustrated in FIG. 1, where white blocks indicate possible WUS, and PO positions whereas the black boxes indicate actual WUS and PO positions.

The specification of Rel-15 WUS is spread out over several parts of the LTE 36-series standard, e.g., 36.211, 36.213, 36.304 and 36.331.

A UE may report its WUS capability to the network, and WUS gap capability, that is, the minimum time required for the UE to start up its main receiver see below. Further WUS information was added in the specification to the paging message/request from Mobility Management Entity (MME) to an eNB, see UE radio paging capabilities. An eNB may use WUS for paging the UE if and only if (IFF) 1) WUS is enabled in the cell, e.g., WUS-Config may be present in System Information (SI), and 2) the UE may support WUS according to the wakeUpSignal-r15 UE capability, see also the description of WUS gap below.

WUS was introduced for both LTE-M and NB-IoT with support for both DRX and extended DRX (eDRX), the former with a 1-to-1 mapping between the WUS and the PO, and for the latter in an addition with the possible configuration of 1-to-N, many, POs. An eNB may configure one WUS gap for UEs using DRX, and another one for UEs using eDRX, see e.g., TS 36.331, version 16.6.0, examples are given for NB-IoT, LTE-M is similar:

WUS-Config-NB information element

| | |
|---|---|
| WUS-Config-NB-r15 ::= | SEQUENCE { |
| maxDurationFactor-r15 | WUS-MaxDurationFactor-NB-r15, |
| numPOs-r15 | ENUMERATED {n1, n2, n4} DEFAULT n1, |
| numDRX-CyclesRelaxed-r15 | ENUMERATED {n1, n2, n4, n8}, |
| timeOffsetDRX-r15 | ENUMERATED {ms40, ms80, ms160, ms240}, |
| timeOffset-eDRX-Short-r15 | ENUMERATED {ms40, ms80, ms160; ms240}, |
| timeOffset-eDRX-Long-r15 | ENUMERATED {ms1000, ms2000} OPTIONAL, -- Need OP |

...
}

| | |
|---|---|
| WUS-ConfigPerCarrier-NB-r15 ::= | SEQUENCE { |
| maxDurationFactor-r15 | WUS-MaxDurationFactor-NB-r15 |

}

| | |
|---|---|
| WUS-MaxDurationFactor-NB-r15 ::= | ENUMERATED {one128th, one64th, one32th, one16th, |
| | oneEighth, oneQuarter, oneHalf} |

WUS-Config-NB field descriptions

timeOffsetDRX
When DRX is used, non-zero gap from the end of the configured
maximum WUS duration to the associated PO, see TS 36.304
[4], clause 7.4 and TS 36.211 [21]. In milliseconds.
Value ms40 corresponds to 40 ms, value ms80 corresponds to 80
ms and so on.
timeOffset-eDRX-Short
When eDRX is used, the short non-zero gap from the end of
the configured maximum WUS duration to the associated PO,
see TS 36.304 [4], clause 7.4 and TS 36.211 [21].
In milliseconds. Value ms40 corresponds to 40 ms, value ms80
corresponds to 80 ms and so on.
E-UTRAN configures timeOffset-eDRX-Short to a value
longer than or equal to timeOffsetDRX.
timeOffset-eDRX-Long
When eDRX is used, the long non-zero gap from the end of
the configured maximum WUS duration to the associated PO, see TS
36.304 [4], clause 7.4 and TS 36.211 [21]. In milliseconds. Value ms1000
corresponds to 1000 ms, value ms2000 corresponds to 2000 ms.

The UE capabilities may also indicate the minimum WUS gaps required for the UE to be able to decode PDCCH in the associated PO, for DRX and eDRX, respectively, see TS 36.331, version 16.6.0:

### UE-RadioPaginginfo-NB Information Element

| | | |
|---|---|---|
| UE-RadioPagingInfo-NB-r13 ::= | SEQUENCE { | |
| ue-Category-NB-r13 | ENUMERATED {nb1} | OPTIONAL, |

...,

| | | |
|---|---|---|
| [[ multiCarrierPaging-r14 | ENUMERATED {true} | OPTIONAL |

]],

| [[ | mixedOperationMode-r15 | ENUMERATED {supported} | OPTIONAL, |
|---|---|---|---|
| | wakeUpSignal-r15 | ENUMERATED {true} | OPTIONAL, |
| | wakeUpSignalMinGap-eDRX-r15 | ENUMERATED {ms40, ms240, ms1000, ms2000} OPTIONAL, | |
| | multiCarrierPagingTDD-r15 | ENUMERATED {true} | OPTIONAL |

]],

| | | | |
|---|---|---|---|
| [[ | ue-Category-NB-r16 | ENUMERATED {nb2} | OPTIONAL, |
| | groupWakeUpSignal-r16 | ENUMERATED {true} | OPTIONAL, |
| | groupWakeUpSignalAlternation-r16 | ENUMERATED {true} | OPTIONAL |

]]
}

wakeUpSignalMinGap-eDRX

wakeUpSignalMinGap-eDRX may be understood to indicate the minimum gap the UE may support between WUS or Group WUS (GWUS) and associated PO in case of eDRX in Frequency Division Duplexing (FDD), as specified in TS 36.304, version 16.5.0. Value ms40 corresponds to 40 ms, value ms240 corresponds to 240 ms and so on. If this field is included, the UE may be required to also indicate support for WUS or GWUS for paging in DRX.

At the end of Rel-15, a longer WUS gap of 1s or 2s was introduced to enable the use of a Wake-Up receiver (WUR), since, starting up the baseband receiver if a WUR is used for the detection of WUS may take longer time. If this is supported in the cell, an eNB may include timeOffset-eDRX-Long in the WUS-Config in SI, see above. In TS 36.304, version 16.5.0, the UE behavior for monitoring paging with WUS is specified, and in Table 7.4-1 it is indicated which WUS time gap the UE and the eNB, may be required to apply depending on the reported UE capability.

Paging with Wake Up Signal

Section 7.4 of TS 36.304, version 16.5.0 describes a specification of paging with wake up signal. According to this specification, paging with Wake Up Signal may only be used in the cell in which the UE most recently entered RRC_IDLE triggered by: a) reception of RRCEarlyDataComplete, or b) reception of RRCConnectionRelease not including noLastCellUpdate, or c) reception of RRCConnectionRelease including noLastCellUpdate and the UE was using (G) WUS in this cell prior to this Radio Resource Control (RRC) connection attempt.

If the UE is in RRC_IDLE, the UE may not be using GWUS according to clause 7.5 and the UE supports WUS, and WUS configuration may be provided in system information, the UE may be required to monitor WUS using the WUS parameters provided in System Information. When DRX is used and the UE detects WUS, the UE may be required to monitor the following PO. When extended DRX is used and the UE detects WUS, the UE may be required to monitor the following numPOs POs or until a paging message including the UE's Non-Access Stratum (NAS) identity may be received, whichever may be earlier. If the UE does not detect WUS, the UE may not be required to monitor the following PO(s). If the UE missed a WUS occasion, e.g., due to cell reselection, it may monitor every PO until the start of the next WUS or until the paging time window (PTW) ends, whichever may be earlier. A PTW may be understood as a time window containing one or more paging occasions (POs) which may be required to be monitored by the UE in eDRX operation.

numPOs=Number of consecutive Paging Occasions (PO) mapped to one WUS provided in system information where (numPOs>1).

The WUS configuration, provided in system information, may include a time-offset between the end of WUS and the start of the first PO of the numPOs POs the UE may be required to monitor. The timeoffset in subframes, used to calculate the start of a subframe go, see TS 36.213, version 16.7.1, may be defined as follows. For a UE using DRX, it may be the signalled timeoffsetDRX. For a UE using eDRX, it may be the signalled timeoffset-eDRX-Short if timeoffset-eDRX-Long is not broadcasted. And for a UE using eDRX, it may be the value determined according to Table 7.4-1 if timeoffset-eDRX-Long is broadcasted.

TABLE 7.4-1
Determination of GAP between end of WUS and associated PO

| | | timeoffset-eDRX-Long | |
|---|---|---|---|
| | | 1000 ms | 2000 ms |
| UE Reported | 40 ms or | timeoffset-eDRX-Short | timeoffset-eDRX-Short |
| wakeUpSignalMinGap-eDRX | not | | |
| | reported | | |
| | 240 ms | timeoffset-eDRX-Short | timeoffset-eDRX-Short |
| | 1000 ms | timeoffset-eDRX-Long | timeoffset-eDRX-Long |
| | 2000 ms | timeoffset-eDRX-Short | timeoffset-eDRX-Long |

The timeoffset may be used to determine the actual subframe g0 as follows, taking into consideration resultant System Frame number (SFN) and/or Hyper Frame SFN (H-SFN) wrap-around of this computation: g0=PO-timeoffset, where PO is the Paging Occasion subframe as defined in clause 7.1.

For a UE using eDRX, the same timeoffset may apply between the end of WUS and associated first PO of the numPOs POs for all the WUS occurrences for a PTW.

The timeoffset, g0, may be used to calculate the start of the WUS as defined in TS 36.213, version 16.7.1.

In essence, the UE may only use WUR, or timeOffset-eDRX-Long, if it may be capable of starting up the main receiver as quickly as indicated by the value used in SI. If not, it may fall back to using timeOffset-eDRX-Short, without WUR.

Since UEs may share PO, the eNB may, in worst case, have to transmit up to 3 WUSs for one PO, for example, corresponding to timeoffsetDRX, timeoffset-eDRX-Short, and timeoffset-eDRX-Long.

FIG. 3 is a schematic diagram illustrating the use of eDRX and DRX WUS gaps for NB-IoT and LTE-M. In the non-limiting example depicted in FIG. 3, a first WUS is transmitted having a timeoffset-eDRX-Long between its transmission and that of the PDCCH in the PO. A second WUS is transmitted having a shorter, timeoffsetDRX, between the transmission of the second WUS and that of the PDCCH in the PO. After the PDCCH, the PDSCH may be transmitted.

### WUS UE Grouping Objective in Rel-16

In the Rel-16 WID, it was agreed that WUS should be further developed to also include UE grouping, such that the number of UEs that may be triggered by a WUS may be further narrowed down to a smaller subset of the UEs that may be associated with a specific paging occasion (PO). The objective was to specify the following set of improvements for machine-type communications for BL/CE UEs: Improved DL transmission efficiency and/or UE power consumption. Particularly, to specify support for UE-group wake-up signal (WUS) [RAN1, RAN2, RAN4].

The purpose may be understood to be to reduce the false paging rate, that is, to avoid that that a given UE may be unnecessarily woken up by a WUS transmission intended for another UE. This feature may be referred to as Rel-16 group WUS, or GWUS. However, this is not directly related to WUR and will not further be explained here.

### Rel-17 NR PEI

In Rel-17, discussions started on introducing a WUS for NR, then called ‘Paging Early Indication’ (PEI). However, since at the time no coverage enhancement was specified for NR, the only gain for Rel-17 PEI was that for the small fraction of UEs in bad coverage and with large synchronization error due to the use of longer DRX cycles. The gain for such UEs was that with the use of PEI they would typically only have to acquire one Synchronisation Signal Block (SSB) before decoding PEI, instead of up to 3 SSBs if PEI was not used, value according to UE vendors. Accordingly, for most UEs, Rel-17 PEI may not result in gains or increased performance.

Rel-17 PEI may also support UE grouping for false paging reduction, similar to the Rel-16 GWUS above, which may have some gains at higher paging load.

In RAN #93e it was agreed that PEI may be PDCCH-based, as seen in from the next subsection, making it much less interesting for WUR, since the main baseband receiver may be understood to be required for decoding PEI. That is, the main baseband received may be understood to not be able to be in sleep state, and therefore there may be no WUR gains.

### Rel-18 NR WUR

In Rel-18, there has been rather large interest to introduce WUR for NR. As explained above, the only specification support needed to be able to use a WUR in the UE, is the specification of a WUS and a long enough time gap between the WUS and the PDCCH in the PO, to allow the UE to start up the main receiver. Therefore, the main difference to Rel-17 PEI may be understood to be that the WUS in Rel-18 should not be PDCCH-based and allow for a simpler and low power receiver, that is, WUR, e.g., using On-Off Keying (OOK), modulation, and non-coherent detection.

In a Rel-18 preparatory email discussion, the moderator's summary for WUR was the following [RP-211664]. A first proposal, Proposal 1 (non-controversial) was, for UE power savings, to focus further RAN discussions on enhancements based on ultra-low power UE receiver and wake up signal, including whether the enhancement may target general purpose use cases or may target specific use cases such as REDCAP, XR. If included as part of Rel-18, relevant work may need to start with a study item to verify the benefits, feasibility, and applicable scenarios. The following was provided as a starting point for further discussions in determining the relevant work scope on UE power savings: a) performance evaluation UE power savings based on ultra-low power UE receiver and wake up signal (RAN1), b) hardware feasibility evaluation (RAN4), c) design of wake up signal for ultra-low power UE receiver (RAN1), and d) relevant procedures (RAN1, RAN2).

However, the WUR was also discussed in the parallel thread on Rel-18 eRedCap and here the conclusions were the following [RP-212221].

The applicability of WUS/WUR was discussed. The common desire was that a specified solution should be usable by all types of UEs, but not limited to RedCap UEs. It was also clarified that the prime targeted use case for this study should be RedCap, i.e., low-end IoT use cases. Studies and normative work on low-power receivers targeting Enhanced Mobile Broadband (eMBB), i.e., smart phone use cases, had been conducted in Rel-16 and Rel-17. Clarification on the relation of the WUS/WUR study to previous work on UE Power Saving was requested. According to the moderators, understanding, previous RAN work was based on existing NR signals, whereas this System Information (SI) is supposed to also look into potentially new signals.

For the so called RedCap evolution, the main goal was to further embrace new use cases, especially requiring low-cost devices and low energy consumption, and particularly, to study low power wake-up receiver/wake-up signal (WUR/WUS). The study was set to target ultra-low power WUS/WUR required by RedCap use cases. The specified solutions were to not be limited to RedCap UEs only. As opposed to the work on UE power savings in previous releases, this study was set to not require existing signals to be used as WUS. Solutions were requested to give justifiable gains compared to the existing Rel-16/17 UE power saving enhancements.

The objectives set were to: a) study use cases, evaluation methodology & Key Performance Indicators (KPIs), and compatibility with other UE power saving solutions, b) study and evaluate low-power wake-up receiver architectures, c) study and evaluate wake-up signal designs to support wake-up receivers, d) study and evaluate protocol changes needed to support wake-up receivers, e) study potential system impact, such as network and other UE's power consumption, coexistence with R17 RedCap and non-RedCap UEs, network coverage.

The power saving/energy efficiency enhancements that were set were enhanced DRX in RRC_INACTIVE (>10.24s), if not completed in R17, and to identify use cases and study corresponding protocol enhancements to support operation on intermittently available energy harvested from the environment. It was noted that how the devices harvest and store energy is outside the scope of 3GPP

That is, it remains to be seen if WUR will be introduced as a RedCap-specific feature under the RedCap Work Item (WI), or as a general NR feature in a separate WI.

For more details on e.g., suggestions on WUR architecture and design, receiver power vs. sensitivity trade-off see e.g., RP-212005, RP-212254, RP-212367, and RP-212427 which were submitted to RAN3 #93-e.

The benefit of WUR may be understood to be to reduce the energy consumption of the receiver, such that unless there is any paging and data for the UE, it may remain in a power saving state. This may extend the battery life of the device, or alternatively enable shorter downlink latency, e.g., shorter DRX, at a fixed battery life. For short-range communication, the WUR power may be low enough, ˜3 uW, that this may even, in combination with energy harvesting, enable that the WUR may be continuously on, that is, DRX or duty-cycling may be not used.

### IEEE WUR

In IEEE, the support for WUR has been specified to a greater extent than in 3GPP. That is, the focus was on low power WUR from the start, and the design may use WUR not only for receiving the WUS but also other control signals and signaling, such as synchronization and mobility information. This may be understood to allow the stations, corresponding to UEs in 3GPP, to only use the WUR when there may be no user-plane data transmission ongoing.

Similar to the 3GPP solution, the use of WUR may only be enabled in stations and not in access points (APs), that is, for downlink communication only. The AP may advertise that it has WUR operation capability, along with WUR configuration parameters, among other info, in which band/channel WUR may be operational, which may be different from the band/channel used for data transmission using the main receiver, e.g., WUR in 2.4 GHz band but data communication in 5 GHz band. Also, it may be noted that the WUR operating channel may be advertised in the legacy beacon, and that the WUR discovery operating channel may be different from the WUR operating channel. Stations may then request to be configured with WUR mode of operation. This request may have to be granted by the AP, and in case it is granted, the station may be further configured/setup for WUR mode of operation, that is, the configuration may be only valid for the connection to the associated AP, and further, the configuration may have to be torn down/de-configured if WUR is not to be used anymore. Both continuous WUR, that is, the receiver open all the time, and duty-cycled WUR, that is, receiver only open during preconfigured time slots, mode of operations may be supported. For the latter, the length of the duty-cycles and on-time during wake up may be part of the WUR configuration.

Unlike the 3GPP solution, the WUR operation mode may be understood to be a “sub-state” of the regular operation and upon the detection of a WUS transmission from the AP, the station may resume the power saving mechanism it may have been configured with before entering the WUR operation mode. That is, IEEE has specified a number of different power saving mechanisms, and for example if duty-cycled monitoring of the downlink has been configured for the station, it may switch to that upon detection of the WUS, unlike the specified 3GPP mechanism which may only cover paging, and the UE may continue to monitor PDCCH if WUS is detected. In this way, the IEEE WUR functionality may be understood to be more general, and may still allow for the station to, upon detection of WUS, “monitor paging” by checking in the beacon from the AP for which stations there is data, or for the station to directly respond with an uplink transmission.

The IEEE WUS does not contain any information for synchronization, and the station may instead have to sync using legacy procedure, that is, using sync info in the beacon from the AP, typically transmitted every 100 ms, or from the transmission to another station. Synchronization to the wireless medium may be understood to refer to the following in IEEE 802.11; a station changing from sleep to awake in order to transmit may have to perform channel clear assessment until it may receive one or more frames that may allow it to correctly set the virtual carrier sensing. This may be understood to be to prevent collisions with transmissions from hidden nodes. In short, the virtual carrier sensing may tell a station to defer for a time period even if the wireless medium may appear to be idle, and may be set by receiving frames that may indicate the duration of an ongoing frame exchange. It may be noted that WiFi is a high Signal to Noise Ratio (SNR) technology and typically, one beacon transmission may be enough to sync for the station, that is, no need to acquire several transmission due to poor coverage. Unlike operation in licensed bands, the station may also have to apply carrier sensing, and also possibly re-acquire channel sensing parameters, before uplink transmission.

The physical wake-up signal (WUS) in IEEE may contain complete frames which may have to be processed by the station. The drawback with this design may be understood to be that it may require more processing and handling and processing in the station, that is, compared to a simple WUR design, which may trigger one pre-defined activity in case WUS may be detected. The benefit may be that it may contain more information and the solution may be more general. The IEEE WUS may contain information to indicate if the WUS may be a WUR sync beacon, see below, a WUR discovery beacon, see below, or a regular WUS, intended to wake the station up. The WUS may also contain proprietary frames, which may e.g., be used to directly turn actuators on/off. The transmission may use on/off keying (OOK) modulation, using Manchester coding, but may be using multi-carrier OOK which may be generated by an Orthogonal Frequency Division Multiplexing (OFDM) transmitter, that is, WUR may be enabled as a software upgrade in APs. The WUS may be 4 MHz wide, but a whole 20 MHz channel may be reserved. The WUS may start with a 20 MHz legacy preamble, to allow other stations to perform carrier sense, followed by 4 MHz Manchester coded OOK. Two data rates may be supported: 62.5 kilo bits per second (kbps) and 250 kbps, and link adaptation may be up to the AP, each packet may be self-contained and include the data rate, that is, in the WUR there may be two possible sync words used to signal the data rate.

The WUS may contain the following information: a) Station Identifier (ID), or group ID, grouping of stations may be supported, b) payload up to 22 bytes, c) short frames may contain only basic information; which WUR frame type+addressing, d) ordinary frames may contain control information, and in addition proprietary information, e) WUR beacons may contain Basic Service Set Identifier (BSS-ID), 12 bits compressed, sync information, time counter, f) similar structure for WUS and WUR beacons, sync words may indicate the data rate, the station may then detect the header, from this, the station may tell if it is WUS or beacon, then check body, and g) WUR discovery frames may contain mobility related information to allow for lower power scan, see below.

Regarding mobility, both WUR sync beacons and WUR discovery beacons have been specified, which may only require the WUR to be used for reception, such that stations may stay in the WUR operation mode unless there is data transmission for the station. That is, stations may only need to switch back to legacy Power Saving Mode (PSM) upon WUS detection, or when moving to a new AP. WUR sync beacons may be used by stations to obtain rough synchronization, for data transmission the legacy beacon may be required to still be acquired, and WUR discovery beacons may be used to carry (legacy) mobility information to enable quick/low energy scanning, allowing stations, only using the WUR, to get information related to local and roaming scans for nearby APs, e.g., Service Set Identity (SSID) and main radio operating channels, if the channel quality should deteriorate.

That is, in the WUR discovery beacon, the AP may indicate one or more Basic Service Set (BSS), and the BSS-ID may have a one-to-one mapping with the assigned SSID name, in which WUR may be supported such that stations may not have to scan all frequencies/channels. Since the WUR discovery beacon may contain the legacy mobility information, there may be some duplication/redundancy in the broadcasted information. This may allow for low power scanning, using only the WUR. Note however that mobility in IEEE may be restricted to the same AP, and that hand-over between APs etc. may not be supported in the same way as in 3GPP. If a station in WUR operation mode moves to a new AP, it may have to move out of WUR operation mode and use the main receiver to obtain the beacon, sync, configuration, and associate to the new AP.

In spite of the benefits of wake-up signals, existing methods to wake-up wireless devices may result in a waste of network resources, as well as energy resources.

### SUMMARY

As part of the development of embodiments herein, one or more challenges with the existing technology will first be identified and discussed.

A wake-up receiver (WUR) may not have the same coverage as the existing main, e.g., baseband, receiver. Incorporating UEs with WUR is therefore problematic in existing networks, for e.g., how to get full service coverage in macro cells. This may be understood to be since the WUR sensitivity may, due to the target to achieve low power, not be good enough to provide the same coverage as e.g., the NR PDCCH physical channel, and therefore, may not cover the whole extent of e.g., macro cells.

According to the foregoing, it is an object of embodiments herein to improve handling a receiver at a wireless device.

According to a first aspect of embodiments herein, the object is achieved by a method, performed by a first node. The method is being for handling a receiver at a wireless device. The first node and the wireless device operate in a wireless communications network. The first node determines whether or not a condition is met. The condition is a measurement of a signal received by the wireless device being above or below a first threshold. The first node then initiates, based on a result of the determining, a procedure. The procedure is to wake-up the wireless device by applying at least one of: a downlink signal to be used, and a receiver to receive the downlink signal to wake-up the wireless device, at the wireless device.

According to a second aspect of embodiments herein, the object is achieved by a method, performed by the second node. The method is for handling the receiver at the wireless device. The second node and the wireless device operate in the wireless communications network. The second node receives the second indication from the first node operating in the wireless communications network. The second indication indicates the result of the determination of whether or not the condition is met. The condition is the measurement of the signal received by the wireless device being above or below the first threshold. The second node then initiates, based on the received second indication, the procedure. The procedure is to wake-up the wireless device by applying at least one of: the downlink signal to be used, and the receiver to receive the downlink signal to wake-up the wireless device, at the wireless device.

According to a third aspect of embodiments herein, the object is achieved by the first node, for handling the receiver at the wireless device. The first node and the wireless device are configured to operate in the wireless communications network. The first node is further configured to determine whether or not the condition is met. The condition is configured to be the measurement of the signal configured to be received by the wireless device being above or below the first threshold. The first node is also configured to initiate, based on the result of the determining, the procedure to wake-up the wireless device. The first node initiates the procedure by applying at least one of: the downlink signal to be used, and the receiver to receive the downlink signal to wake-up the wireless device, at the wireless device.

According to a fourth aspect of embodiments herein, the object is achieved by the second node, for handling the receiver at the wireless device. The second node and the wireless device are configured to operate in the wireless communications network. The second node is further configured to receive the second indication from the first node configured to operate in the wireless communications network. The second indication is configured to indicate the result of the determination of whether or not the condition is met. The condition is configured to be the measurement of the signal configured to be received by the wireless device being above or below the first threshold. The second node is also configured to initiate, based on the second indication configured to be received, the procedure to wake-up the wireless device. The second node initiates the procedure by applying at least one of: the downlink signal to be used, and the receiver configured to receive the downlink signal to wake-up the wireless device, at the wireless device.

By determining whether or not the condition is met, and then initiating the procedure based on the result of determining, the first node may be enabled to, based on the condition, adaptively apply WUR to make it work in macro cell deployments. The rationale for this may be understood to be that, as long as the coverage of the cell may be good enough for the WUR to be sensitive enough to detect incoming signals, usage of the WUR may provide benefits, such as reduced energy consumption. However, as soon as the coverage may worsen below a limit, such that detection of incoming signals by the WUR may no longer be guaranteed, usage of the WUR may no longer be advantageous, and therefore its use may be temporarily paused.

By the second node receiving the second indication indicating the result of the determination by the first node of whether or not the condition is met, and then initiating the procedure based on the second indication, the second node may be enabled to be aware of whether the first node may be using WUR or not, and act accordingly. For example, the second indication may indicate a report of measured RSRP or whether the wireless device may have changed WUR state or mode of operation. The second node may then as a non-limiting example of the latter case, e.g., know it may page the wireless device any time, or if it may need to page the wireless device in the first occurring DRX on-duration.

### BRIEF DESCRIPTION OF THE DRAWINGS

Examples of embodiments herein are described in more detail with reference to the accompanying drawings, according to the following description.

FIG. 1 is a schematic diagram depicting an illustration of a location of a WUS and the paging occasion to which it is associated.

FIG. 2 is a schematic diagram depicting an illustration of WUS for NB-IoT and LTE-M.

FIG. 3 is a schematic diagram illustrating the use of eDRX and DRX WUS gaps for NB-IoT and LTE-M.

FIG. 4 is a schematic diagram depicting an example of a wireless communications network, according to embodiments herein.

FIG. 5 is a flowchart depicting a method in a first node, according to embodiments herein.

FIG. 6 is a flowchart depicting a method in a second node, according to embodiments herein.

FIG. 7 is a schematic diagram illustrating a non-limiting example of a conditional use of a receiver to, e.g., specifically, receive the downlink signal to wake-up the wireless device 130, e.g., WUR depending on measured RSRP, according to examples of embodiments herein.

FIG. 8 is a schematic diagram illustrating another non-limiting example of a conditional use of ‘Continuous WUR’ (C-WUR) or ‘DRX WUR’ (DRX-WUR) depending on measured RSRP, according to examples of embodiments herein.

FIG. 9 is a schematic block diagram illustrating two embodiments, in panel a) and panel b), of a first node, according to embodiments herein.

FIG. 10 is a schematic block diagram illustrating two embodiments, in panel a) and panel b), of a second node, according to embodiments herein.

FIG. 11 is a schematic block diagram illustrating a telecommunication network connected via an intermediate network to a host computer, according to embodiments herein.

FIG. 12 is a generalized block diagram of a host computer communicating via a base station with a user equipment over a partially wireless connection, according to embodiments herein.

FIG. 13 is a flowchart depicting embodiments of a method in a communications system including a host computer, a base station and a user equipment, according to embodiments herein.

FIG. 14 is a flowchart depicting embodiments of a method in a communications system including a host computer, a base station and a user equipment, according to embodiments herein.

FIG. 15 is a flowchart depicting embodiments of a method in a communications system including a host computer, a base station and a user equipment, according to embodiments herein.

FIG. 16 is a flowchart depicting embodiments of a method in a communications system including a host computer, a base station and a user equipment, according to embodiments herein.

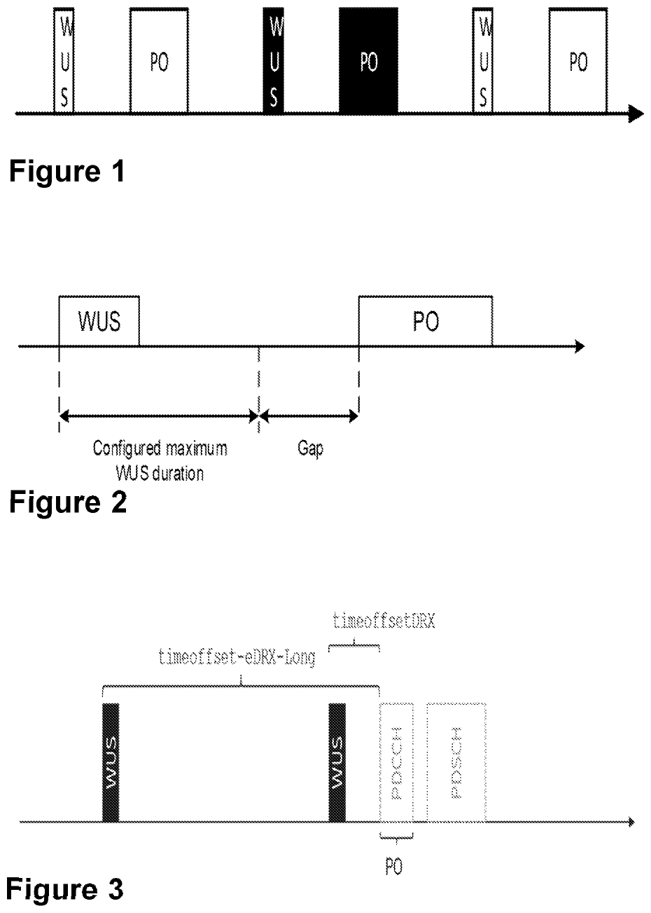

### DETAILED DESCRIPTION

Certain aspects of the present disclosure and their embodiments may provide solutions to the challenges presented in the Summary section or other challenges. Embodiments herein may be generally understood to relate to different aspects of providing a conditional use of a Wake-up Receiver. Embodiments herein may be understood to provide methods according to which UEs may monitor the downlink, e.g. paging, using the WUR or not, depending on the coverage.

In some examples, a UE may use WUR if a measurement, e.g., Reference Signal Received Power (RSRP), is above a configurable, e.g., RSRP, threshold. If not, it may use legacy monitoring of the downlink.

In some examples, the UE may use ‘continuous WUR’ if a measurement, e.g., RSRP, is above a configurable, e.g., RSRP, threshold. If not, it may use DRX-based, e.g., duty-cycled, WUR for monitoring the downlink, e.g., paging. The rationale for this may be understood to be that the WUR may be understood to also have an active and an inactive power, where the inactive may be understood to be lower. Duty-cycling may therefore lead to an overall lower energy consumption. If letting the WUR be continuously in an active state may need to then match this average energy consumption, the WUR power for the always-on WUR may be understood to need to be reduced, with means lower sensitivity and worse coverage.

The sensitivity of WURs may be understood to typically limit them to use in more short-range scenarios. Embodiments herein may be understood to provide a method to adaptively apply WUR to make it work in macro cell deployments etc.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

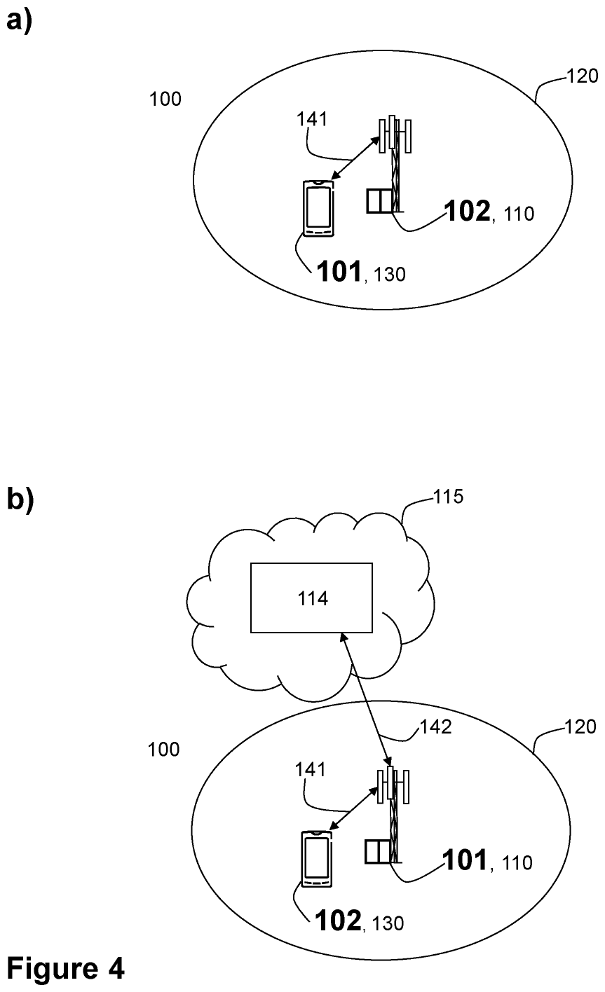

FIG. 4 depicts two non-limiting examples, in panel a) and panel b), respectively, of a wireless network or wireless communications network 100, sometimes also referred to as a wireless communications system, cellular radio system, or cellular network, in which embodiments herein may be implemented. The wireless communications network 100 may be a 5G system, 5G network, or Next Gen System or network. In other examples, the wireless communications network 100 may instead, or in addition, support other technologies such as, for example, Long-Term Evolution (LTE), e.g. LTE-M, LTE Frequency Division Duplex (FDD), LTE Time Division Duplex (TDD), LTE Half-Duplex Frequency Division Duplex (HD-FDD), LTE operating in an unlicensed band, such as LTE Licensed-Assisted Access (LAA), enhanced LAA (eLAA), further enhanced LAA (feLAA) and/or MulteFire. The wireless communications network 100 may typically support MTC, enhanced MTC (eMTC), IoT and/or NB-IoT. Yet in other examples, the wireless communications network 100 may support other technologies such as, for example Wideband Code Division Multiple Access (WCDMA), Universal Terrestrial Radio Access (UTRA) TDD, Global System for Mobile communications (GSM) network, GSM/Enhanced Data Rates for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), or any cellular network or system. Thus, although terminology from 5G/NR and LTE may be used in this disclosure to exemplify embodiments herein, this should not be seen as limiting the scope of the embodiments herein to only the aforementioned system.

The wireless communications network 100 may comprise a plurality of nodes, whereof a first node 101 and a second node 102 are depicted in the non-limiting examples of FIG. 4. Any of the first node 101 and the second node 102 may be a wireless device, such as the wireless device 130 described below. Any of the first node 101 and the second node 102 may be a network node, such as the network node 110 described below. The network node 110 may be serving the wireless device 130. In embodiments wherein the first node 101 may be the wireless device 130, the second node 102 may be the network node 110, as e.g., depicted in the non-limiting example of panel a) of FIG. 4. In embodiments wherein the first node 101 may be the network node 110, the second node 102 may be the wireless device 130, as e.g., depicted in the non-limiting example of panel b) of FIG. 4.

The wireless communications network 100 may comprise a plurality of network nodes, whereof a network node 110 is depicted in the non-limiting example of FIG. 4. The network node 110 may be a radio network node. That is, a transmission point such as a radio base station, for example a gNB, an eNB, an eNodeB, or a Home Node B, a Home eNode B, or any other network node with similar features capable of serving a user equipment, such as a wireless device or a machine type communication device, in the wireless communications network 100. In some examples, such as that depicted in FIG. 4b, the network node 110 may be a distributed node, and may partially perform its functions in collaboration with a virtual node 114 in a cloud 115.

The wireless communications network 100 may cover a geographical area, which in some embodiments may be divided into cell areas, wherein each cell area may be served by a radio network node, although, one radio network node may serve one or several cells. In the example of FIG. 4, the network node 110 serves a cell 120. The network node 110 may be of different classes, such as, e.g., macro eNodeB, home eNodeB or pico base station, based on transmission power and thereby also cell size. In some examples, the network node 110 may serve receiving nodes with serving beams. The radio network node may support one or several communication technologies, and its name may depend on the technology and terminology used. Any of the radio network nodes that may be comprised in the communications network 100 may be directly connected to one or more core networks.

A plurality of wireless devices may be located in the wireless communication network 100, whereof a wireless device 130, is depicted in the non-limiting example of FIG. 4. The wireless device 130 comprised in the wireless communications network 100 may be a wireless communication device such as a 5G UE, or a UE, which may also be known as e.g., mobile terminal, wireless terminal and/or mobile station, a mobile telephone, cellular telephone, laptop with wireless capability, a sensor, or an IoT device, just to mention some further examples. Any of the wireless devices comprised in the wireless communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, a sensor, IoT device, NB-IoT device, device equipped with a wireless interface, such as a printer or a file storage device, modem, or any other radio network unit capable of communicating over a radio link in a communications system. The wireless device 130 comprised in the wireless communications network 100 may be enabled to communicate wirelessly in the wireless communications network 100. The communication may be performed e.g., via a RAN, and possibly the one or more core networks, which may be comprised within the wireless communications network 100.

The first node 101 may be configured to communicate within the wireless communications network 100 with the second node 102 over a first link 141, e.g., a radio link. The network node 110 may be configured to communicate within the wireless communications network 100 with the virtual network node 114 over a second link 142, e.g., a radio link or a wired link.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first” and/or “second” herein may be understood to be an arbitrary way to denote different elements or entities, and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a wireless device, such as the wireless device 130, e.g., a 5G UE or a UE, and embodiments related to a network node, such as the network node 110, e.g., a gNB or an eNB.

Some embodiments herein will now be further described with some non-limiting examples.

In the following description, any reference to a/the UE, or simply “UE” may be understood to equally refer to the wireless device 130; any reference to a/the gNB, may be understood to equally refer to the network node 110; any reference to a/the WUS(s) may be understood to equally refer to the downlink signal, that is, to wake-up the one or more wireless devices 130; any reference to a/the WUR may be understood to equally refer to the receiver to, e.g., specifically, receive the downlink signal to wake-up the one or more wireless devices 130, e.g., the wireless device 130; any reference to the a/the cell may be understood to equally refer to the cell 120.

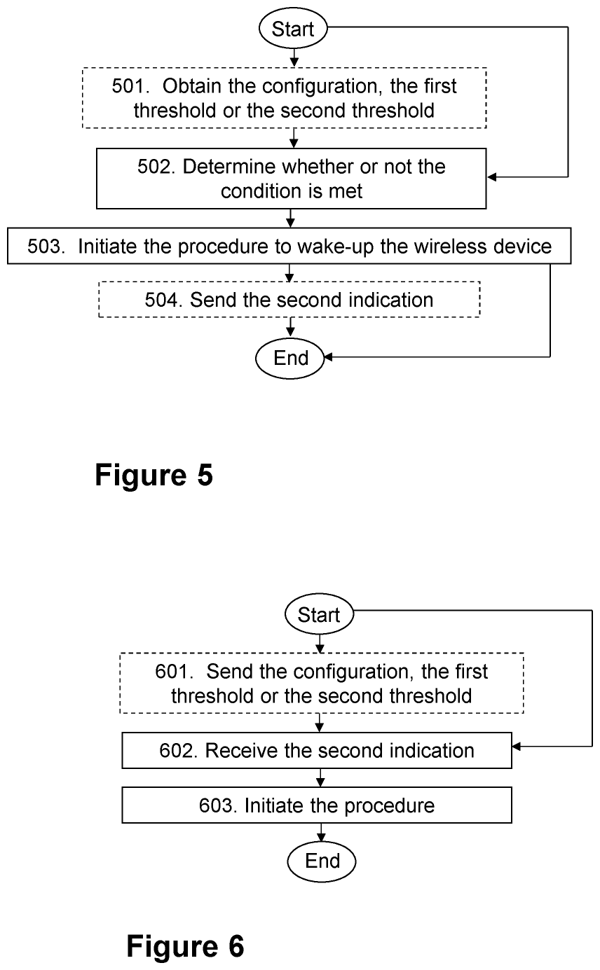

Embodiments of a method performed by a node, such as the first node 101 will now be described with reference to the flowchart depicted in FIG. 5. The method may be understood to be for handling a receiver at a wireless device, such as the wireless device 130. The first node 101 and the wireless device 130 operate in a wireless communications network, such as the wireless communications network 100.

In some embodiments, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

The first node 101 may be one of the network node 110 serving the wireless device 130 and the wireless device 130.

The receiver may be a Wake-Up Receiver (WUR).

The wireless communications network 100 may be a Fifth Generation network.

Several embodiments are comprised herein. In some embodiments, all the actions may be performed. In some embodiments, two or more actions may be performed. It should be noted that the examples herein are not mutually exclusive. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the first node 101 is depicted in FIG. 5. Examples of these actions and the indications which will be described are provided in this document. Some actions may be performed in a different order than that shown FIG. 5.

In FIG. 5, optional actions in some embodiments may be represented with dashed lines.

### Action 501

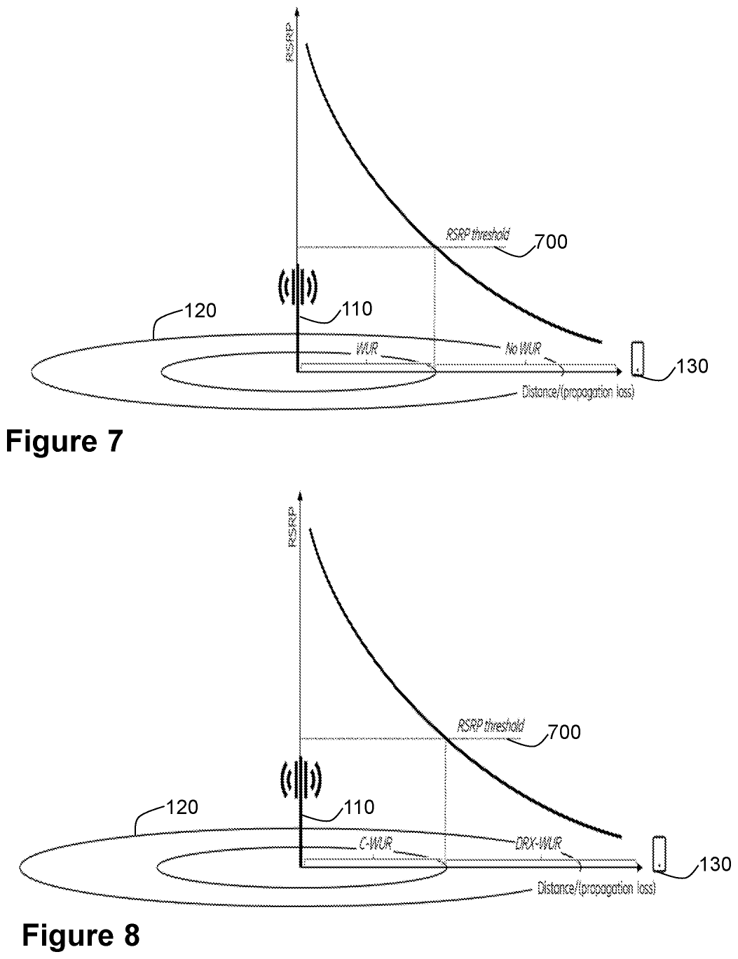

Embodiments herein may be understood to be related to a conditional use of a WUR. That is, the WUR may only be used by the wireless device 130, and/or WUS may only be transmitted to the wireless device 130, if certain conditions are fulfilled. For each parameter/condition, a defining range or threshold may be specified for when WUR may be applicable. For example, for a coverage condition, which will be described later, the RSRP measured on a physical channel, e.g., SSB, may need to be above a configurable RSRP threshold. This is schematically illustrated with an example in FIG. 7.

In this Action 501, the first node 101 may obtain at least one of: a configuration comprising a condition, a first threshold and a second threshold.

The condition is a measurement of a signal received by the wireless device 130 being above or below the first threshold. The measurement may be, e.g., measured Reference Signal Received Power (RSRP), or Reference Signal Received Quality (RSRQ). The measurement of the signal may be using for example SSB, ‘WUR-SSB’, ‘WUR sync’, Phase Tracking Reference signal (PTRS), Channel State Information Reference Signal (CSI-RS), etc.

That the measurement of the signal may be above or below the first threshold may be understood to mean that the condition may be formulated as for example, that the receiver, e.g., WUR, may be used with the proviso RSRP is above the first threshold, or that the receiver, e.g., WUR, may not be used with the proviso RSRP is below the first threshold.

In some embodiments, the conditional application of WUR may depend on any, e.g., combination, of the following conditions, e.g., in combination with the measurement of the signal being above or below the first threshold. In some embodiments, the condition may further comprise one of the following options.

According to a first option, the condition may further comprise, one or more indications of coverage at the cell 120 comprised in the wireless communications network 100 wherein the wireless device 130 may be located or receiving service. For example, the condition may be that the measured RSRP in the cell 120 may be above the first threshold, which may be understood to be an indication of the coverage of the cell 120.

According to a second option, the condition may further comprise, a length of a discontinuous reception (DRX) cycle being above the second threshold. For example, the wireless device 130 using DRX cycle length within a certain range, e.g., duty-cycle length. The rationale being that the WUR energy saving gains may be understood to become insignificant at longer DRX cycles, e.g., in comparison with regular DRX or eDRX operation. See also the fifth option on downlink latency below.

According to a third option, the condition may further comprise, an authorization for the wireless device 130 to use the receiver, e.g., WUR. That is, the third option may be that the wireless device 130 may have toe authorized for WUR operation in the wireless communications network 100, e.g., indicated in the subscription profile of the wireless device 130, or by the use of a certain Service Profile Identifier, or SPID.

According to a fourth option, the condition may further comprise a first configuration of the wireless device 130 for the receiver, e.g., WUR, being compatible with a second configuration for the receiver, e.g., WUR, at the cell 120 comprised in the wireless communications network 100 wherein the wireless device 130 may be located or receiving service, e.g., at the time of the determining whether or not the condition is met, as will be described in Action 502. The fourth option may comprise, for example, the WUR capabilities of the wireless device 130 matching the requirements and/or configuration announced for WUR in the cell 120 by the network node 110, or in the wireless communications network 100 overall. For example, the condition may be the WUR implementation of the wireless device 130 being compatible with WUR type that may be accepted in the cell 120, or the WUR configuration used in the cell 120, e.g., as signaled in SI. It may be noted that the WUR capabilities of the wireless device 130 may be provided directly from the wireless device 130, or retrieved from a Core Network (CN) node, e.g., the Access and Mobility Management Function (AMF) for NR.

According to a fifth option, the condition may further comprise, a use of the receiver, e.g., WUR, meeting a downlink latency requirement. The use of WUR may help to achieve a lower downlink latency, e.g., using a shorter DRX cycle length the lower power of the WUR may achieve the same energy consumption as using the main receiver with a longer DRX cycle. On the other hand, when the wireless device 130 may be paged, it may take some time to start up the main receiver, which may add to the downlink latency. Therefore, the downlink latency requirement, potentially in combination with the DRX cycle length used, may determine if it may be favourable for the wireless device 130 to use WUR or not. In other words, since WUR operation may be understood to lower the energy consumption, one may be able to afford a shorter Duty/DRX-cycle which may be understood to reduce the DL latency. But the price to pay may than be that the WUR may have introduced a lower limit for DL latency in the form of the main receiver start-up time. For example, a start up of a main receiver may take 2 seconds. In average, the network may have to wait half the DRX cycle length before the wireless device 130 may become available in downlink. Therefore, if the DRX cycle is longer than 4 seconds it may be beneficial for the wireless device 130 to use WUR, either reducing the energy consumption or enabling the use of shorter DRX cycles and hence reducing the downlink latency. However, for DRX cycles shorter than 2 seconds it may be understood to be better for the downlink latency to use the main receiver for monitoring paging. This may be understood to be because, for example, if the DRX/duty-cycle is 1s, a UE may check for incoming data every 1s. In legacy operation, with DRX, a UE may be able to respond immediately, whereas with WUR there may be understood to be an additional 2s wait time to start up the main receiver.

According to a sixth option the condition may further comprise, a first indication to use the receiver, e.g., WUR, being received from the wireless device 130. This condition may be understood to apply to embodiments wherein the first node 101 may be the network node 110. The first indication may be a request to use WUR, be configured with WUR mode of operation, or to be configured to a WUR state, received from the wireless device 130.

According to a seventh option, the condition may further comprise, a first capability to use the receiver, e.g., WUR, by the wireless device 130 matching a second capability by the cell 120 to use the receiver, e.g., WUR. The WUR capability of the wireless device 130 may be another condition, possibly extending to the type, or receiver class, or WUR which may be supported by the wireless device 130, and comparing that to what may be signaling to be supported or used in the cell 130, e.g., in system information broadcast.

According to an eighth option, the condition may further be, specific to the wireless device 130.

According to a ninth option, the condition may further be a first identity of the wireless device 130.

In a second, e.g., alternative in some cases, group of examples, cell-specific configuration of WUR may be used rather than UE-specific configuration. That is, instead of configuring WUR per UE, all UEs in a cell, such as the cell 120, may be configured with either WUR or not. This decision may be based on the, hypothetical, “worst UE” in the cell 120, e.g., in terms of coverage, downlink latency requirement, DRX cycle length, etc. For example, the use of WUR in the cell 120 may be based on the RSRP measurement for a UE on the cell-edge, either real or hypothetical. In this way, WUR may be used in relatively smaller cells, and not in relatively larger cells.

Thus, according to a tenth option, the condition may further be, specific to the cell 120.

According to an eleventh option, the condition may further be, a second identity of the cell 120.

In some embodiments, the condition may be at least one of: a) expiration of a timer, and b) explicit indication from the network node 110 serving the wireless device 130. That is, the network node 110 that may be providing coverage to the wireless device 130. Further details on these embodiments will be provided in the description of Action 503.

Accordingly, obtaining may therefore be, e.g., receiving from the network node 110, e.g., via the first link 141, or another node, or retrieving from a memory. The threshold may, in some examples, either be determined by the network and signaled to UEs such as the wireless device 130, in SI, hard-coded in specifications, or determined from an expression in specifications.

If several WUR types are supported, one RSRP-threshold may be provided per WUR type. Alternatively, the RSRP-threshold to be applied may be obtained from an expression, e.g., a function of the sensitivity, the amount of power used for active receivers, e.g., also if it is adaptive in “adaptive” receivers, or any other characteristic of the WUR receiver. That is, in WUR receiver design there may be a trade-off between sensitivity and energy consumption, e.g., power. That is, the more “active” the receiver is, the more power it may use and the better sensitivity it may have. Better sensitivity in turn may mean better coverage. The different WUR types above may therefore refer to different classes of WUR receivers, with different configured RSRP-thresholds, for some WUR, operation in the full may be supported, while for others not. If the wireless device 130 has an “adaptive” receiver, it may, from the broadcast of different RSRP-thresholds broadcasted, the WUR receiver classes now corresponding to different WUR activity levels, determine at which power level the wireless device 130 may need to operate to have sufficient coverage, but at the same time minimize the receiver power consumption. Note that in this example, there would typically be WUR coverage in the entire cell, but the same principle as above may be applied. That is, there may be switching on and off for WUR operation depending on the RSRP/coverage, but here the switching/thresholds may be different for different WUR classes.

In some examples, the condition may be a coverage condition, e.g., a coverage level coverage level in the cell 120, or an extent of coverage. In some particular embodiments, the condition may be a coverage level in the cell 120 comprised in the wireless communications network 100 wherein the wireless device 130 may be located or receiving service. This option may comprise the wireless device 130 being in a certain coverage, e.g. measured RSRP, or RSRQ.

Moreover, the thresholds may be selected based on DL Power Spectral Density (PSD).

As stated above, the first node 101 may be one of the network node 110 serving the wireless device 130 and the wireless device 130. There may be some aspects related to the first node 101 as the wireless device 130, which may be understood to be UE aspects. The condition may further determine if the wireless device 130 may be required to use WUR for monitoring the downlink, e.g. for paging. It may be noted that a gNB such as the network node 110 may always send WUS when paging the wireless device 130, e.g. anywhere in the cell 120, but the wireless device 130 may selectively monitor using WUR only when certain conditions may be fulfilled, e.g., the coverage is good enough.

There may be some aspects related to the first node 101 as the network node 110, or NW aspects. The condition may further determine if the network node 110 may need to transmit a WUS to reach the wireless device 130 in downlink, e.g., for paging. It may be noted that for some dynamically changing conditions listed above, e.g., the current measured RSRP of the wireless device 130, signaling in UL may be required to inform the network. This may add signaling overhead when there may be no user-plane data transmission and may be understood to be typically unwanted. Therefore, in some cases, only the UE aspect may be specified for such dynamically changing conditions. The network and the network node 110 may typically then only avoid sending unnecessary WUS for the (semi-) static conditions listed above, e.g., DRX cycle-length, WUR authorization, etc., Alternatively, the use of WUR may be specified as a UE state, see below, and the wireless device 130 may, e.g., report to the network when the measured RSRP may become smaller or larger than the RSRP-threshold, to move it in and out for such a WUR state.

As to configurational aspects, RSRP-thresholds, or the configuration for any other condition, may be configured in system information broadcast, e.g., in the WUR configuration for the cell 120 provided by common RRC signaling. Based on this information and definition, the wireless device 130 may determine if WUR may need to be used, and the network node 110 if WUS may need to be transmitted to the wireless device 130 based on the same information and definition. Note that the application of WUR above may also be implemented by a new UE state, e.g., a new RRC state or a ‘WUR mode of operation’. The conditions above may then implicitly determine the entering and existing of this mode or state. As discussed above, it may also be implicitly determined whether to use WUR, or WUR mode of operation, for a UE such as the wireless device 130, or if explicit signaling may be used to move the wireless device 130 in and out of WUR mode.

By obtaining the at least one of: the configuration comprising the condition, the first threshold and the second threshold, the first node 101 may then be enabled to determine whether or not the condition is met in Action 502. This may be understood to enable the first node 101 to, based on the condition, adaptively apply WUR to make it work in macro cell deployments, that is, deployments with cells of large size and for wireless devices in poor coverage. The rationale for this may be understood to be that, as long as the wireless device 130 may be in good coverage, a WUR with worse sensitivity compared to the main receiver may still detect incoming signals, usage of the WUR may provide benefits, such as reduced energy consumption of the wireless device 130. However, as soon as the coverage may worsen below a limit, such that detection of incoming signals by the WUR may no longer be guaranteed, usage of the WUR may no longer be advantageous, and therefore its use may be temporarily paused. In the absence of embodiments herein, a UE may then become unreachable by the network.

### Action 502

In this Action 502, the first node 101 may determines whether or not the condition is met. Determining in this Action 502 may comprise deciding, calculating or checking, e.g., based on received information, e.g., such as measurement information or an indication of whether or not the condition is met.

The condition is the measurement of the signal received by the wireless device 130 being above or below the first threshold.

In some embodiments, the condition may further comprise one of the options described in Action 501.

As just explained, by determining whether or not the condition is met in this Action 502, the first node 101 may be enabled to, based on the condition, adaptively apply WUR to make it work in macro cell deployments, that is, deployments with cells of large size and for wireless devices in poor coverage. The rationale for this may be understood to be that, as long as the wireless device 130 may be in good coverage, a WUR with worse sensitivity compared to the main receiver may still detect incoming signals, usage of the WUR may provide benefits, such as reduced energy consumption of the wireless device 130. However, as soon as the coverage may worsen below a limit, such that detection of incoming signals by the WUR may no longer be guaranteed, usage of the WUR may no longer be advantageous, and therefore its use may be temporarily paused. In the absence of embodiments herein, a UE may then become unreachable by the network.

### Action 503

In this Action 503, the first node 101 initiates, based on a result of the determining in Action 502, a procedure. The procedure is to wake-up the wireless device 130 by applying at least one of: a downlink signal to be used, and a receiver to, e.g., specifically, receive the downlink signal to wake-up the wireless device 130 at the wireless device 130. For example, the receiver may be, e.g., a Wake-Up Receiver (WUR).

The “procedure to wake-up the wireless device 130” may be, e.g., WUR operation. The procedure may be understood as a certain way to behave in order to handle how to bring certain components in the wireless device 130 out of a sleep state.

The expression “to wake-up the wireless device 130” may be understood in context that, when the wireless device 130 may be in WUR operation, the main receiver, the associated baseband processing, and other components but this new WUR may be put in a deep sleep state. While in WUR operation, these components in the deep sleep state may be started up upon detection of WUS.

By the first node 101 initiating the procedure, e.g., WUR operation, based on the result of the determining Action 502, WUR may be enabled to be used only in a part of the cell 120. That is, the procedure, e.g., WUR operation, both in the wireless device 130 and the network, may be switched on and off depending on the result of the determining performed in Action 502, e.g., the measured RSRP.

The downlink signal may be understood to be, e.g., another signal, than the signal the measurement of which being above or below the first threshold may be the condition described in Action 501 and Action 502.

In some examples, with the proviso the first node 101 may be the network node 110, the procedure that may be initiated in this Action 503 may be to wake-up the wireless device 130 by applying the downlink signal to be used to wake-up the wireless device 130. With the proviso the first node 101 may be the wireless device 130, the procedure that may be initiated in this Action 503 may be to wake-up the wireless device 130 by applying the receiver to, e.g., receive the downlink signal to wake-up the wireless device 130 at the wireless device 130.

The downlink signal to wake-up the wireless device 130 may be, e.g., a WUS.

Initiating may be understood as triggering, enabling, facilitating or starting.

In some embodiments, the applying in this Action 503 may comprise entering a different state of a plurality of states defined for the wireless device 130. In some of such embodiments, the condition may define a trigger to enter the state.

The WUR state may, in some examples, be introduced as a version of the NR Mobile Initiated Communication Only (MICO) or LTE Power Saving Mode (PSM). In MICO and PSM, the wireless device 130 may be effectively powered down and in a sleep state to reduce the energy consumption of the wireless device 130, and may not be reached by the network. The wireless device 130 may be only reachable in the downlink in an ‘active time’ window, in which DRX may be applied, following either uplink initiation transmission, or relatively infrequent registration- or tracking-an area update. The MICO and PSM approaches may therefore be best suited for a UE with requirements on long UE battery life, and with either only uplink originated traffic, such as sensors, or with very relaxed latency requirements for the downlink.

In some embodiments, the first node 101 may be the network node 110. In some of such embodiments, the applying in this Action 503 may comprise entering a mode of operation of a plurality of modes of operation. The plurality of modes of operation may comprise one of: a) continuous monitoring with the receiver, e.g., WUR, and b) discontinuous monitoring with the receiver, e.g., WUR, for example, duty-cycled WUR monitoring.

With the use of WUR, the wireless device 130 may more frequently monitor the downlink for incoming transmissions, and even in the most extreme case of continuous-WUR, continuously monitor the DL. In another example, a WUR state may instead be a sub-state to Connected state, either RRC_CONNECTED or CM_CONNECTED. That is, the wireless device 130 may be able to pause, relax, or suspend all connected mode procedures, e.g., mobility measurements, measurement reporting, PDCCH monitoring, etc., which may be not relying on WUR and initiated by the network by a WUS transmission.

Some things may be common for any new WUR state, both the MICO/PSM, or Connected state outlined above: some procedures may possibly have to be maintained by the wireless device 130 in the new WUR state in addition to the WUS monitoring, for example, re-synchronization and cell detection to ensure the wireless device 130 may be still connected to the same or strongest cell, e.g., channel quality or signal strength detection. Selected Idle mode procedures may for example be adopted in this new state if needed, e.g., cell (re-) selection procedure. Triggers for entering and exiting the new WUR state may also be needed. The wireless device 130 may exit the WUR state and return to legacy operation/procedure upon detection of WUS, and the wireless device 130 may enter the WUR state upon any of the following: i) explicit indication from the network node 110, e.g., in Downlink Control Information (DCI), Radio Resource Control (RRC), or Non-Access Stratum (NAS) signaling, ii) expiration of a timer, e.g., reusing an existing timer such as the inactivityTimer or defining a new timer, and iii) re-interpretation of existing signaling when the wireless device 130 may be configured with WUR, e.g., the reception of RRCRelease message. In accordance with the foregoing, as stated earlier, in some embodiments, the condition may be at least one of: a) the expiration of the timer, and b) the explicit indication from the network node 110 serving the wireless device 130.

Whether to use WUS when paging a UE such as the wireless device 130 may also be left to network implementation; the network node 110 may try paging without WUS the first time, and then, if there is no response, with WUS the second time. Or the network may learn that the coverage is the same for the wireless device 130, e.g., that it is stationary, and may then determine, as outlined here, if WUS may need to be used or not, e.g., with a fallback to using WUS if the wireless device 130 does not respond to paging. Or, as already mentioned, the network may apply the “hands-off” approach and always page the wireless device 130 using WUS, and leave for the wireless device 130 the use of WUR to detect this WUS, or use legacy procedure to detect paging, e.g., monitor PDCCH with the main receiver.

### Conditional Use of Continuous-WUR or DRX-WUR

In a second part of embodiments herein, the same conditions and logic as in the examples previously described may be applied, but instead, to determine if ‘continuous WUR’ or ‘DRX WUR’ may need to be used for the wireless device 130. That is, which mode of operation of WUR to apply. ‘Continuous WUR’ may be understood to refer to the wireless device 130 having the WUR receiver open all the time, that is, the network may reach the wireless device 130 at any point in time. ‘DRX WUR’ may be understood to refer to duty-cycled operation of the WUR. That is, the wireless device 130 may be only monitoring the downlink using the WUR in pre-determined paging- or WUS-occasions.

The rationale for this part of embodiments herein may be understood to be that when coverage is poor, a higher power WUR design may be required, e.g., a more “active” receiver with better sensitivity. To achieve the same overall energy consumption, e.g., to still have the same UE battery life or still being able to operate on harvested energy, e.g., average energy consumption below the energy harvesting “floor”, the WUR operation may be required to then be duty-cycled to allow the wireless device 130 to sleep in between downlink monitoring occasions in order to conserve energy, e.g., ‘DRX WUR’. Or the other way around, if it may be possible to have the WUR open all the time in the ‘continuous WUR’ case, the WUR power may need to be extremely low. This low power may lead to poor sensitivity and hence poor coverage. Therefore, ‘DRX WUR’ may be feasible in poor coverage scenarios, whereas ‘continuous WUR’ may be feasible in good coverage scenarios. The coverage condition, e.g., using an RSRP-threshold, may therefore be very useful to select between ‘continuous WUR’ mode of operation, ‘DRX WUR’ mode of operation, or determining the DRX cycle length. This is schematically illustrated with an example in FIG. 8.

It may be noted that, unless the wireless device 130 is stationary, the measured RSRP may change over time and therefore the network may not know the current RSRP estimate of the wireless device 130 and may not know whether it is in ‘Continuous WUR’ mode or ‘DRX WUR’ mode when the wireless device 130 may be about to be paged. Unlike in the first example above, where the network may always transmit WUS and leave to the wireless device 130 to decode it or not, the network may need here to know when the wireless device 130 may be reachable/available in the downlink. The network may of course only attempt to reach the wireless device 130 during the DRX on-durations, but then all benefits for ‘Continuous WUR’ may be lost and there may be understood to be no point of supporting it in the first place. There may be a few approaches to solve this.

A first approach may be the wireless device 130 reporting of measured RSRP. This may be understood to have clear drawbacks associated to signaling overhead, as discussed above. In an improvement of this, the wireless device 130 may only report when the measured RSRP may become smaller, or larger, than the configured RSRP-threshold, possibly with some hysteresis parameter applied. This may be understood to limit the signaling, and correspond to the wireless device 130 indicating to the network when it switched between different WUR states or mode of operation.

A second approach may be that cell-specific configuration may be used rather than UE-specific configuration. That is, instead of configuring C-WUR or DRX-WUR per UE, all UEs in cell 120 may be configured with either C-WUR or DRX-WUR. This decision may be taken based on the RSRP measurement for a UE on the cell-edge, either real or hypothetical. In this way, DRX-WUR may be used for larger cell sizes, and C-DRX only for small cell sizes.

A third approach may be that the network may attempt to page the wireless device 130 at any time, e.g., directly when downlink data or control signaling arrives, assuming that the wireless device 130 is using ‘C-WUR’. If there is no response, the network may page the wireless device 130 in the first occurring DRX on-duration, assuming the wireless device 130 is using ‘DRX-WUR’.

A fourth approach may be that a request to use continuous-WUR, be configured with WUR mode of operation, or to be configured to a WUR state, is received from the wireless device 130.

A fifth approach may be related to the WUR capability of the wireless device 130. Possibly extending to the type, or receiver class, or WUR which may be supported by the wireless device 130, and comparing that to what may be signaling to be supported or used in the cell 120, e.g., in system information broadcast.

Simultaneous Application of Conditional WUR on/Off and Type of WUR Operation

It may be noted that both the examples of when the condition may be for determining whether to use WUR or not, and the examples of when the condition may be for the type of WUR operation may be applied simultaneously in the same cell 120, but then using different conditions, or at least different thresholds for the conditions. One example of this may be for the coverage, e.g., using RSRP-threshold; in very poor coverage, WUR may not be used by the wireless device 130, in medium coverage ‘DRX WUR’ may be used by the wireless device 130, and in good coverage ‘continuous WUR’ may be used be wireless device 130.

As explained earlier, by initiating the procedure based on the result of determining whether or not the condition is met in this Action 503, the first node 101 may be enabled to, based on the condition, adaptively apply WUR to make it work in macro cell deployments, that is, in cells of large size and when the wireless device 130 may be in poor coverage.

### Action 504

In some embodiments wherein the first node 101 may be the wireless device 130, the method may further comprise that, in this Action 504, the first node 101 may send the second indication operating in the wireless communications network 100. The sending of the second indication may be to the second node 102, e.g., the network node 110 serving the wireless device 130. The second indication may indicate a result of the determination in Action 502.

The sending in this Action 504 may comprise e.g., transmitting e.g., via the first link 141.

In some examples the sending of the second indication may be performed before, or at the same time as the initiating of the procedure in Action 503.

By the first node 101 sending the second indication to the second node 102, the first node 101 may enable the second node 102 to be aware of whether the first node 101 may be using WUR or not, and act accordingly. For example, the second indication may indicate a report of measured RSRP or whether the wireless device 130 may have changed WUR state or mode of operation. The second node 102 may then as a non-limiting example of the latter case, e.g., know it may page the wireless device 130 any time, or if it may need to page the wireless device 130 in the first occurring DRX on-duration.

Embodiments of a method, performed by a second node, such as the second node 102, will now be described with reference to the flowchart depicted in FIG. 6. The method may be understood to be for handling the receiver at a wireless device, such as the wireless device 130. The second node 102 and the wireless device 130 operate in a wireless communications network, such as the wireless communications network 100.

The receiver may be the Wake-Up Receiver (WUR).

In some embodiments, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

Several embodiments are comprised herein. The first method may comprise two or more of the following actions. In some embodiments, all the actions may be performed. It should be noted that the examples herein are not mutually exclusive. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the second node 102 is depicted in FIG. 6. In FIG. 6, an optional action in some embodiments may be represented with dashed lines.

The detailed description of some of the following corresponds to the same references provided above, in relation to the actions described for the first node 101 and will thus not be repeated here to simplify the description. For example, the downlink signal to wake-up the wireless device 130 may be, e.g., a WUS.

### Action 601

In this Action 601, the second node 102 may send, to the first node 101, at least one of: the configuration comprising the condition, the first threshold and the second threshold.

As stated above, the first node 101 may be one of the network node 110 serving the wireless device 130 and the wireless device 130.

In particular examples, the second node 102 may be the network node 110, e.g., in embodiments wherein the first node 101 may be the wireless device 130.

The condition may be the measurement of the signal received by the wireless device 130 being above or below the first threshold.

In some embodiments, the condition may further comprise one of the following options.

According to the first option, the condition may further comprise, the one or more indications of coverage at the cell 120 comprised in the wireless communications network 100 wherein the wireless device 130 may be located or receiving service.

According to the second option, the condition may further comprise, the length of the DRX cycle being above the second threshold.

According to the third option, the condition may further comprise, the authorization for the wireless device 130 to use the receiver, e.g., WUR.

According to the fourth option, the condition may further comprise the first configuration of the wireless device 130 for the receiver, e.g., WUR, being compatible with the second configuration for the receiver, e.g., WUR, at the cell 120 comprised in the wireless communications network 100 wherein the wireless device 130 may be located or receiving service.

According to the fifth option, the condition may further comprise, the use of the receiver, e.g., WUR, meeting the downlink latency requirement.

According to the sixth option the condition may further comprise, the first indication to use the receiver, e.g., WUR, being received from the wireless device 130.

According to the seventh option, the condition may further comprise, the first capability to use the receiver, e.g., WUR, by the wireless device 130 matching the second capability by the cell 120 to use the receiver, e.g., WUR.

According to the eighth option, the condition may, e.g., further, be, specific to the wireless device 130.

According to the ninth option, the condition may, e.g., further, be the first identity of the wireless device 130.

Thus, according to the tenth option, the condition may, e.g., further, be specific to the cell 120.

According to the eleventh option, the condition may, e.g., further, be the second identity of the cell 120.

In some embodiments, the condition may be at least one of: a) the expiration of the timer, and b) the explicit indication from the network node 110 serving the wireless device 130. That is, the network node 110 that may be providing coverage to the wireless device 130

In some particular embodiments, the condition may be a coverage condition, e.g., the coverage level in the cell 120 comprised in the wireless communications network 100 wherein the wireless device 130 may be located or receiving service, or an extent of coverage.

### Action 602

In this Action 602, the second node 102 receives the second indication from the first node 101 operating in the wireless communications network 100.

The receiving in this Action 602 may be performed e.g., via the first link 141.

The first node 101 may be one of the network node 110 serving the wireless device 130 and the wireless device 130.

The second indication indicates the result of the determination, e.g., the determination performed in Action 502, of whether or not the condition is met.

The condition is the measurement of the signal received by the wireless device 130 being above or below the first threshold.

In some embodiments, the condition may further comprise one of the options described in Action 601.

This Action 602 may be performed in examples wherein the first node 101 may be the wireless device 130.

Action 603

In this Action 603, the second node 102 initiates, based on the received second indication, the procedure, and therefore, based on the result of the determining of Action 502.

Initiating may be understood as triggering, enabling, facilitating or starting.

The procedure is to wake-up the wireless device 130 by applying at least one of: the downlink signal to be used, and the receiver to, e.g., specifically, receive the downlink signal to wake-up the wireless device 130 at the wireless device 130.

The downlink signal may be understood to be, e.g., another signal, than the signal the measurement of which being above or below the first threshold may be the condition described in Action 501 and Action 502.

For example, the receiver may be, e.g., a Wake-Up Receiver (WUR).

In some embodiments, the applying in this Action 603 may comprise entering the different state of the plurality of states defined for the wireless device 130. In some of such embodiments, the condition may define the trigger to enter the state.

In some embodiments, the first node 101 may be the network node 110. In some of such embodiments, the applying in this Action 603 may comprise entering the mode of operation of the plurality of modes of operation. The plurality of modes of operation may comprise one of: a) the continuous monitoring with the receiver, e.g., WUR, and b) the discontinuous monitoring with the receiver, e.g., WUR., for example, duty-cycled WUR monitoring.

FIG. 7 is a schematic diagram illustrating a non-limiting example of conditional use of WUR depending on measured RSRP, according to embodiments herein. The network node 110 and the wireless device 130 are depicted in FIG. 7, as well as the cell 120. As schematically represented in the Figure, the RSRP that may be measured by the wireless device 130 may decrease in a manner which may be inversely proportional to the distance from the network node 110, such that, the larger the distance, the larger the propagation loss. The first threshold is also depicted in FIG. 7 as an RSRP threshold 700. The first node 101 may determine whether or not a measurement of a signal received by the wireless device 130 is above or below the first threshold 700. With the proviso the measurement of the signal is above the first threshold 700, the first node 101 may initiate the procedure to wake-up the wireless device 130 by applying at least one of: the downlink signal to be used, e.g, WUS, and the WUR to receive the downlink signal to wake-up the wireless device 130. With the proviso the measurement of the signal is below the first threshold 700, the first node 101 may refrain from initiating the procedure to wake-up the wireless device 130 by applying at least one of: the downlink signal to be used, e.g, WUS, and the WUR to receive the downlink signal to wake-up the wireless device 130, indicated as “No WUR” in FIG. 7. As stated above, the first node 101 may be one of the network node 110 and the wireless device 130.

FIG. 8 is a schematic diagram illustrating a non-limiting example of conditional use of ‘Continuous WUR’ (C-WUR) or ‘DRX WUR’ (DRX-WUR) depending on measured RSRP. The network node 110 and the wireless device 130 are depicted in FIG. 8, as well as the cell 120. As schematically represented in the Figure, the RSRP that may be measured by the wireless device 130 may decrease in a manner which may be inversely proportional to the distance from the network node 110, such that, the larger the distance, the larger the propagation loss. The first threshold is also depicted in FIG. 8 as the RSRP threshold 700. The first node 101 may determine whether or not a measurement of a signal received by the wireless device 130 is above or below the first threshold 700. With the proviso the measurement of the signal is above the first threshold 700, the first node 101 may enter the mode of operation of continuous monitoring with the WUR, indicated as C-WUR in FIG. 8. With the proviso the measurement of the signal is below the first threshold 700, the first node 101 may enter the mode of operation of discontinuous monitoring with the receiver, indicated as DRX-WUR in FIG. 8. The first node 101 may be one of the network node 110 and the wireless device 130.

Certain embodiments disclosed herein may provide one or more of the following technical advantage(s), which may be summarized as follows. Embodiments herein may be understood to enable the use of WUR in UEs such as the wireless device 130 also in a macro cell, and other long-range, deployments.

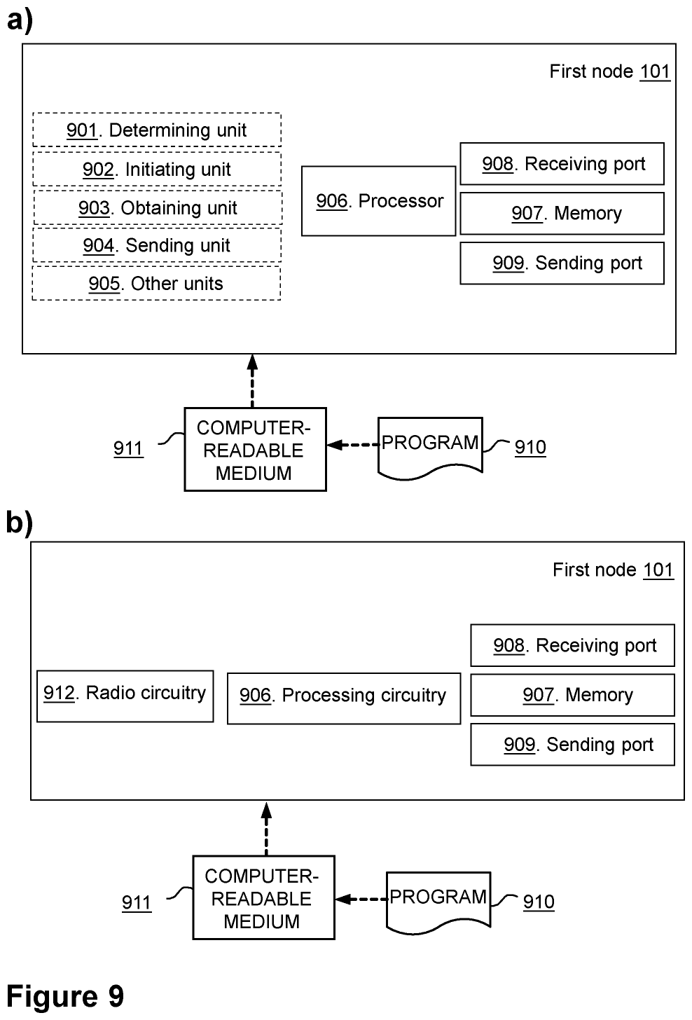

FIG. 9 depicts two different examples in panels a) and b), respectively, of the arrangement that the first node 101 may comprise to perform the method actions described above in relation to FIG. 5, FIG. 7 and/or FIG. 8. In some embodiments, the first node 101 may comprise the following arrangement depicted in FIG. 9a. The first node 101 may be understood to be for handling the receiver at the wireless device 130. The first node 101 and the wireless device 130 are configured to operate in the wireless communications network 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first node 101, and will thus not be repeated here. For example, the downlink signal to wake-up the wireless device 130 may be, e.g., a WUS.

In FIG. 9, optional units are indicated with dashed boxes.

The first node 101 is configured to perform the determining of Action 502, e.g. by means of a determining unit 901 within the first node 101 configured to, determine whether or not the condition is met. The condition is configured to be the measurement of the signal configured to be received by the wireless device 130 being above or below the first threshold.

The first node 101 is configured to perform the initiating of Action 503, e.g. by means of an initiating unit 902 within the first node 101 configured to, initiate, based on the result of the determining, the procedure to wake-up the wireless device 130. The first node 101 initiates the procedure by applying at least one of: the downlink signal to be used, and the receiver to receive the downlink signal to wake-up the wireless device 130 at the wireless device 130.

In some embodiments, the first node 101 may be configured to be one of the network node 110 configured to be serving the wireless device 130 and the wireless device 130.

In some embodiments, the condition may be further configured to comprise one of: i) the one or more indications of coverage at the cell 120 configured to be comprised in the wireless communications network 100 wherein the wireless device 130 may be configured to be located or receiving service, ii) the length of the discontinuous reception cycle being above the second threshold, iii) the authorization for the wireless device 130 to use the receiver, iv) the first configuration of the wireless device 130 for the receiver being configured to be compatible with the second configuration for the receiver at the cell 120 configured to be comprised in the wireless communications network 100 wherein the wireless device 130 may be configured to be located or receiving service, v) the use of the receiver meeting the downlink latency requirement, vi) the first indication to use the receiver being received from the wireless device 130, vii) the first capability to use the receiver by the wireless device 130 matching the second capability by the cell 120 to use the receiver, and/or the condition may be configured to be one of: viii) specific to the wireless device 130, ix) the first identity of the wireless device 130, x) specific to the cell 120, and xi) the second identity of the cell 120.

In some embodiments, the first node 101 may be configured to perform the obtaining of Action 501, e.g. by means of an obtaining unit 903 within the first node 101, configured to obtain at least one of: the configuration configured to be comprising the condition, the first threshold and the second threshold.

In some embodiments, the applying may be configured to comprise entering a different state of the plurality of states configured to be defined for the wireless device 130, and the condition may be configured to define the trigger to enter the state.

In some embodiments, the condition may be configured to be at least one of: a) expiration of the timer, and b) explicit indication from the network node 110 configured to be serving the wireless device 130.

In some embodiments wherein the first node 101 may be configured to be the wireless device 130, the first node 101 may be configured to perform the sending of Action 504, e.g. by means of a sending unit 904 within the first node 101, configured to send the second indication to the second node 102 configured to operate in the wireless communications network 100, e.g., the network node 110 serving the wireless device 130. The second indication may be configured to indicate the result of the determination.

In some embodiments, wherein the first node 101 may be configured to be the network node 110, the applying may be configured to comprise entering a mode of operation of the plurality of modes of operation configured to comprise one of: a) continuous monitoring with the receiver and b) discontinuous monitoring with the receiver.

In some embodiments, the condition may be configured to be the coverage level in the cell 120 configured to be comprised in the wireless communications network 100 wherein the wireless device 130 may be configured to be located or receiving service.

In some embodiments, the receiver may be configured to be a Wake-Up Receiver (WUR).

Other units 905 may be comprised in the first node 101.

The embodiments herein in the first node 101 may be implemented through one or more processors, such as a processor 906 in the first node 101 depicted in FIG. 9a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first node 101. One such carrier may be in the form of a CD ROM disc. It is however feasible with other data carriers such as a memory stick. The computer program code may furthermore be provided as pure program code on a server and downloaded to the first node 101.

The first node 101 may further comprise a memory 907 comprising one or more memory units. The memory 907 is arranged to be used to store obtained information, store data, configurations, schedulings, and applications etc. to perform the methods herein when being executed in the first node 101.

In some embodiments, the first node 101 may receive information from, e.g., the second node 102, the network node 110, the wireless device 130 or another node, through a receiving port 908. In some embodiments, the receiving port 908 may be, for example, connected to one or more antennas in first node 101. In other embodiments, the first node 101 may receive information from another structure in the wireless communications network 100 through the receiving port 908. Since the receiving port 908 may be in communication with the processor 906, the receiving port 908 may then send the received information to the processor 906. The receiving port 908 may also be configured to receive other information.

The processor 906 in the first node 101 may be further configured to transmit or send information to e.g., the second node 102, the network node 110, the wireless device 130, another node, or another structure in the wireless communications network 100, through a sending port 909, which may be in communication with the processor 906, and the memory 907.

Those skilled in the art will also appreciate that the different units 901-905 described above may refer to a combination of analog and digital modules, and/or one or more processors configured with software and/or firmware, e.g., stored in memory, that, when executed by the one or more processors such as the processor 906, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 901-905 described above may be implemented as one or more applications running on one or more processors such as the processor 906.

Thus, the methods according to the embodiments described herein for the first node 101 may be respectively implemented by means of a computer program 910 product, comprising instructions, i.e., software code portions, which, when executed on at least one processor 906, cause the at least one processor 906 to carry out the actions described herein, as performed by the first node 101. The computer program 910 product may be stored on a computer-readable storage medium 911. The computer-readable storage medium 911, having stored thereon the computer program 910, may comprise instructions which, when executed on at least one processor 906, cause the at least one processor 906 to carry out the actions described herein, as performed by the first node 101. In some embodiments, the computer-readable storage medium 911 may be a non-transitory computer-readable storage medium, such as a CD ROM disc, or a memory stick. In other embodiments, the computer program 910 product may be stored on a carrier containing the computer program 910 just described, wherein the carrier is one of an electronic signal, optical signal, radio signal, or the computer-readable storage medium 911, as described above.

The first node 101 may comprise a communication interface configured to facilitate communications between the first node 101 and other nodes or devices, e.g., the second node 102, the network node 110, the wireless device 130, another node, or another structure in the wireless communications network 100. The interface may, for example, include a transceiver configured to transmit and receive radio signals over an air interface in accordance with a suitable standard.

In other embodiments, the first node 101 may comprise the following arrangement depicted in FIG. 9b. The first node 101 may comprise a processing circuitry 906, e.g., one or more processors such as the processor 906, in the first node 101 and the memory 907. The first node 101 may also comprise a radio circuitry 912, which may comprise e.g., the receiving port 908 and the sending port 909. The processing circuitry 912 may be configured to, or operable to, perform the method actions according to FIG. 5, FIG. 7 and/or FIG. 8, in a similar manner as that described in relation to FIG. 9a. The radio circuitry 912 may be configured to set up and maintain at least a wireless connection with the second node 102, the network node 110, the wireless device 130, another node, or another structure in the wireless communications network 100. Circuitry may be understood herein as a hardware component.

Hence, embodiments herein also relate to the first node 101 comprising the processing circuitry 906 and the memory 907, said memory 907 containing instructions executable by said processing circuitry 906, whereby the first node 101 is operative to perform the actions described herein in relation to the first node 101, e.g., in FIG. 5, FIG. 7 and/or FIG. 8.

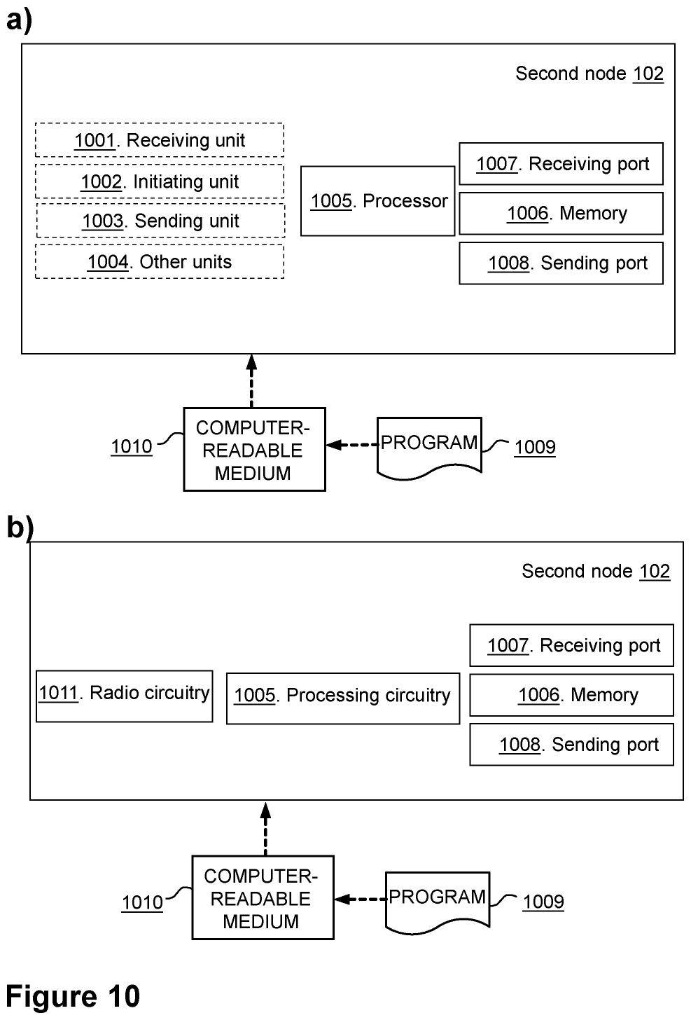

FIG. 10 depicts two different examples in panels a) and b), respectively, of the arrangement that the second node 102 may comprise to perform the method actions described above in relation to FIG. 6, FIG. 7 and/or FIG. 8. In some embodiments, the second node 102 may comprise the following arrangement depicted in FIG. 10a. The second node 102 may be understood to be for handling the receiver at the wireless device 130. The second node 102 and the wireless device 130 are configured to operate in the wireless communications network 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the wireless device 130 and will thus not be repeated here. For example, the downlink signal to wake-up the wireless device 130 may be, e.g., a WUS.

In FIG. 10, optional modules are indicated with dashed boxes.

The second node 102 is configured to perform the receiving of Action 602, e.g. by means of a receiving unit 1001 within the second node 102, configured to receive the second indication from the first node 101 configured to operate in the wireless communications network 100. The second indication is configured to indicate the result of the determination of whether or not the condition is met. The condition is configured to be the measurement of the signal configured to be received by the wireless device 130 being above or below the first threshold.

The second node 102 is configured to perform the initiating of Action 603, e.g. by means of an initiating unit 1002 within the second node 102, configured to initiate, based on the second indication configured to be received, the procedure to wake-up the wireless device 130. The second node 102 initiates the procedure by applying at least one of: the downlink signal to be used, and the receiver configured to receive the downlink signal to wake-up the wireless device 130 at the wireless device 130.

In some embodiments, the first node 101 may be configured to be one of the network node 110 configured to be serving the wireless device 130 and the wireless device 130.

In particular examples, the second node 102 may be configured to be the network node 110, e.g., in embodiments wherein the first node 101 may be configured to be the wireless device 130.

In some embodiments, the condition may be further configured to comprise one of: i) the one or more indications of coverage at the cell 120 configured to be comprised in the wireless communications network 100 wherein the wireless device 130 may be configured to be located or receiving service, ii) the length of the discontinuous reception cycle being above the second threshold, iii) the authorization for the wireless device 130 to use the receiver, iv) the first configuration of the wireless device 130 for the receiver being configured to be compatible with the second configuration for the receiver at the cell 120 configured to be comprised in the wireless communications network 100 wherein the wireless device 130 may be configured to be located or receiving service, v) the use of the receiver meeting the downlink latency requirement, vi) the first indication to use the receiver being received from the wireless device 130, vii) the first capability to use the receiver by the wireless device 130 matching the second capability by the cell 120 to use the receiver, and/or the condition may be configured to be one of: viii) specific to the wireless device 130, ix) the first identity of the wireless device 130, x) specific to the cell 120, and xi) the second identity of the cell 120.

The second node 102 may be configured to perform the sending of Action 601, e.g. by means of a sending unit 1003 within the second node 102, configured to send, to the first node 101, at least one of: the configuration configured to comprise the condition, the first threshold and the second threshold.

In some embodiments, the applying may be configured to comprise entering a different state of the plurality of states configured to be defined for the wireless device 130, and the condition may be configured to define the trigger to enter the state.

In some embodiments, the condition may be configured to be at least one of: a) expiration of the timer, and b) explicit indication from the network node 110 configured to be serving the wireless device 130.

In some embodiments, wherein the first node 101 may be configured to be the network node 110, the applying may be configured to comprise entering a mode of operation of the plurality of modes of operation configured to comprise one of: a) continuous monitoring with the receiver and b) discontinuous monitoring with the receiver.

In some embodiments, the condition may be configured to be the coverage level in the cell 120 configured to be comprised in the wireless communications network 100 wherein the wireless device 130 may be configured to be located or receiving service.

In some embodiments, the receiver may be configured to be a Wake-Up Receiver (WUR).

Other units 1004 may be comprised in the second node 102.

The embodiments herein in the second node 102 may be implemented through one or more processors, such as a processor 1005 in the second node 102 depicted in FIG. 10a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second node 102. One such carrier may be in the form of a CD ROM disc. It is however feasible with other data carriers such as a memory stick. The computer program code may furthermore be provided as pure program code on a server and downloaded to the second node 102.

The second node 102 may further comprise a memory 1006 comprising one or more memory units. The memory 1006 is arranged to be used to store obtained information, store data, configurations, schedulings, and applications etc. to perform the methods herein when being executed in the second node 102.

In some embodiments, the second node 102 may receive information from, e.g., the first node 101, the network node 110, the wireless device 130 or another node, through a receiving port 1007. In some embodiments, the receiving port 1007 may be, for example, connected to one or more antennas in second node 102. In other embodiments, the second node 102 may receive information from another structure in the wireless communications network 100 through the receiving port 1007. Since the receiving port 1007 may be in communication with the processor 1005, the receiving port 1007 may then send the received information to the processor 1005. The receiving port 1007 may also be configured to receive other information.

The processor 1005 in the second node 102 may be further configured to transmit or send information to e.g., the first node 101, the network node 110, the wireless device 130, another node, or another structure in the wireless communications network 100, through a sending port 1008, which may be in communication with the processor 1005, and the memory 1006.

Those skilled in the art will also appreciate that the different units 1001-1004 described above may refer to a combination of analog and digital modules, and/or one or more processors configured with software and/or firmware, e.g., stored in memory, that, when executed by the one or more processors such as the processor 1005, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1001-1004 described above may be implemented as one or more applications running on one or more processors such as the processor 1005.

Thus, the methods according to the embodiments described herein for the second node 102 may be respectively implemented by means of a computer program 1009 product, comprising instructions, i.e., software code portions, which, when executed on at least one processor 1005, cause the at least one processor 1005 to carry out the actions described herein, as performed by the second node 102. The computer program 1009 product may be stored on a computer-readable storage medium 1010. The computer-readable storage medium 1010, having stored thereon the computer program 1009, may comprise instructions which, when executed on at least one processor 1005, cause the at least one processor 1005 to carry out the actions described herein, as performed by the second node 102. In some embodiments, the computer-readable storage medium 1010 may be a non-transitory computer-readable storage medium, such as a CD ROM disc, or a memory stick. In other embodiments, the computer program 1009 product may be stored on a carrier containing the computer program 1009 just described, wherein the carrier is one of an electronic signal, optical signal, radio signal, or the computer-readable storage medium 1010, as described above.

The second node 102 may comprise a communication interface configured to facilitate communications between the second node 102 and other nodes or devices, e.g., the first node 101, the network node 110, the wireless device 130, another node, or another structure in the wireless communications network 100. The interface may, for example, include a transceiver configured to transmit and receive radio signals over an air interface in accordance with a suitable standard.

In other embodiments, the second node 102 may comprise the following arrangement depicted in FIG. 10b. The second node 102 may comprise a processing circuitry 1005, e.g., one or more processors such as the processor 1005, in the second node 102 and the memory 1006. The second node 102 may also comprise a radio circuitry 1011, which may comprise e.g., the receiving port 1007 and the sending port 1008. The processing circuitry 1005 may be configured to, or operable to, perform the method actions according to FIG. 6, FIG. 7 and/or FIG. 8, in a similar manner as that described in relation to FIG. 10a. The radio circuitry 1011 may be configured to set up and maintain at least a wireless connection with the first node 101, the network node 110, the wireless device 130, another node, or another structure in the wireless communications network 100. Circuitry may be understood herein as a hardware component.

Hence, embodiments herein also relate to the second node 102 comprising the processing circuitry 1005 and the memory 1006, said memory 1006 containing instructions executable by said processing circuitry 1005, whereby the second node 102 is operative to perform the actions described herein in relation to the second node 102, e.g., in FIG. 6, FIG. 7 and/or FIG. 8.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

### EXAMPLES of, or Related to, Embodiments Herein

Examples related to embodiments herein may be as follows.

The first node 101 embodiments relate to FIG. 5, FIG. 7, FIG. 8 and FIGS. QQ4-QQ9.

A method, performed by a node, such as the first node 101 is described herein. The method may be understood to be for handling a receiver at a wireless device, such as the wireless device 130. The first node 101 may be operating in a wireless communications network, such as the wireless communications network 100.

The first method may comprise one or more of the following actions. In some embodiments, all the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the first node 101 is depicted in FIG. 4. In FIG. 4, optional actions in some embodiments may be represented with dashed lines.

Determining 502 whether or not a condition is met. The first node 101 may be configured to perform this determining action 502, e.g. by means of a determining unit 901 within the first node 101, configured to perform this action.

Determining in this Action 502 may comprise deciding, calculating or checking, e.g., based on received information, e.g., such as measurement information or an indication of whether or not the condition is met.

The condition may be one of:
one or more indications of coverage at the cell 120 comprised in the wireless communications network 100 wherein the wireless device 130 may be located or receiving service,
a measurement of a signal received by the wireless device 130 being above or below a first threshold,
a length of a discontinuous reception cycle being above a second threshold,
an authorization for the wireless device 130 to use the receiver, e.g., WUR,
a first configuration of the wireless device 130 for the receiver, e.g., WUR, being compatible with a second configuration for the receiver, e.g., WUR, at the cell 120 comprised in the wireless communications network 100 wherein the wireless device 130 may be located or receiving service, e.g., at the time of the determining 502,
a use of the receiver, e.g., WUR, meeting a downlink latency requirement,
a first indication to use the receiver, e.g., WUR, being received from the wireless device 130,
a first capability to use the receiver, e.g., WUR, by the wireless device 130 matching a second capability by the cell 120 to use the receiver, e.g., WUR,
specific to the wireless device 130,
a first identity of the wireless device 130,
specific to the cell 120, and
a second identity of the cell 120.

In some examples, the condition may be a coverage condition, e.g., a coverage level coverage level in the cell 120, or an extent of coverage.

Initiating 503 a procedure. The first node 101 may be configured to perform this initiating action 503, e.g. by means of an initiating unit 902 within the first node 101, configured to perform this action.

The initiating of the procedure in this Action 503 may be based on a result of the determining of Action 502.

Initiating may be understood as triggering, enabling, facilitating or starting.

The procedure may be to wake-up the wireless device 130 by applying at least one of: a downlink signal to be used, and a receiver at the wireless device 130.

The receiver may be to, e.g., specifically, receive the downlink signal to wake-up the wireless device 130. For example, the receiver may be, e.g., a Wake-Up Receiver (WUR).

The downlink signal to wake-up the wireless device 130 may be, e.g., a WUS.

In some embodiments, the applying in this Action 503 may comprise entering a different state of a plurality of states defined for the wireless device 130. In some of such embodiments, the condition may define a trigger to enter the state.

In some embodiments, the condition may be at least one of:
expiration of a timer, and
explicit indication from the network node 110 serving the wireless device 130, that is, the network node 110 that may be providing coverage to the wireless device 130.

In some embodiments, the first node 101 may be the network node 110. In some of such embodiments, the applying in this Action 503 may comprise entering a mode of operation of a plurality of modes of operation. The plurality of modes of operation may comprise one of: a continuous monitoring with the receiver, e.g., WUR, and a discontinuous monitoring with the receiver, e.g., WUR., for example, duty-cycled WUR monitoring.

In some embodiments, the method may further comprise one or more of the following actions:

Obtaining 501 at least one of: a configuration comprising the condition, the first threshold and the second threshold. The first node 101 may be configured to perform this obtaining action 501, e.g. by means of an obtaining unit 903 within the first node 101, configured to perform this action.

Obtaining may be, e.g., receiving from the network node 110 or another node, or retrieving from a memory.

Sending 504 a second indication. The first node 101 may be configured to perform this sending action 504, e.g. by means of a sending unit 904 within the first node 101, configured to perform this action.

The sending in this Action 504 may comprise e.g., transmitting e.g., via the first link 141.

The sending of the second indication may be to the network node 110 serving the wireless device 130.

The second indication may indicate a result of the determination in Action 502.

This Action 504 may be performed in examples wherein the first node 101 is the wireless device 130.

In some examples the sending of the second indication may be performed before, or at the same time as the initiating of the procedure in Action 503.

Other units 905 may be comprised in the first node 101.

The first node 101 may also be configured to communicate user data with a host application unit in a host computer QQ510, e.g., via another link such as QQ560.

In FIG. 9, optional units are indicated with dashed boxes.

The first node 101 may comprise an interface unit to facilitate communications between the first node 101 and other nodes or devices, e.g., the second node 102, the network node 110, the wireless device 130, the host computer QQ510, or any of the other nodes. In some particular examples, the interface may, for example, include a transceiver configured to transmit and receive radio signals over an air interface in accordance with a suitable standard.

The first node 101 may comprise an arrangement as shown in FIG. 9 or in FIG. QQ5.

The second node 102 embodiments relate to FIG. 6, FIG. 7, FIG. 8 and FIGS. QQ4-QQ9.

A method, performed by a second node, such as the second node 102, is described herein. The method may be understood to be for handling a receiver at a wireless device, such as the wireless device 130. The second node 102 may be operating in a wireless communications network, such as the wireless communications network 100.

The first method may comprise one or more of the following actions. In some embodiments, all the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the second node 102 is depicted in FIG. 5. In FIG. 5, optional actions in some embodiments may be represented with dashed lines.

The detailed description of some of the following corresponds to the same references provided above, in relation to the actions described for the first node 102 and will thus not be repeated here to simplify the description. For example, the downlink signal to wake-up the wireless device 130 may be, e.g., a WUS.

Receiving 602 the second indication. The second node 102 may be configured to perform this receiving action 602, e.g. by means of a receiving unit 1001 within the second node 102, configured to perform this action.

The receiving of the second indication may be from the first node 101 operating in the wireless communications network 100.

The receiving in this Action 602 may be performed e.g., via the first link 141.

The first node 101 may be one of the network node 110 serving the wireless device 130 and the wireless device 130.

The second indication may indicate a result of a determination, e.g., the determination performed in Action 502, of whether or not a condition is met.

The condition may be one of:
the one or more indications of coverage at the cell 120 comprised in the wireless communications network 100 wherein the wireless device 130 may be located or receiving service,
the measurement of a signal, e.g., another signal, received by the wireless device 130 being above or below the first threshold,
the length of the discontinuous reception cycle being above the second threshold,
the authorization for the wireless device 130 to use the receiver, e.g., WUR,
the first configuration of the wireless device 130 for the receiver, e.g., WUR, being compatible with the second configuration for the receiver, e.g., WUR, at the cell 120 comprised in the wireless communications network 100 wherein the wireless device 130 may be located or receiving service,
the use of the receiver, e.g., WUR, meeting the downlink latency requirement,
the first indication to use the receiver, e.g., WUR, being received from the wireless device 130,
the first capability to use the receiver, e.g., WUR, by the wireless device 130 matching the second capability by the cell 120 to use the receiver, e.g., WUR,
specific to the wireless device 130,
the first identity of the wireless device 130,
the specific to the cell 120, and
the second identity of the cell 120.

In some examples, the condition may be a coverage condition, e.g., a coverage level coverage level in the cell 120, or an extent of coverage.

This Action 602 may be performed in examples wherein the first node 101 may be the wireless device 130.

Initiating 603 the procedure. The second node 102 may be configured to perform this initiating action 603, e.g. by means of an initiating unit 1002 within the second node 102, configured to perform this action.

The initiating of the procedure in this Action 603 may be based on the received second indication. And therefore, based on the result of the determining of Action 502.

Initiating may be understood as triggering, enabling, facilitating or starting.

The procedure may be to wake-up the wireless device 130 by applying at least one of: the downlink signal to be used, and the receiver at the wireless device 130.

The receiver may be to, e.g., specifically, receive the downlink signal to wake-up the wireless device 130. For example, the receiver may be, e.g., a Wake-Up Receiver (WUR).

In some embodiments, the applying in this Action 603 may comprise entering the different state of the plurality of states defined for the wireless device 130. In some of such embodiments, the condition may define the trigger to enter the state.

In some embodiments, the condition may be at least one of:
expiration of the timer, and
the explicit indication from the network node 110 serving the wireless device 130, that is, the network node 110 that may be providing coverage to the wireless device 130.

In some embodiments, the first node 101 may be the network node 110. In some of such embodiments, the applying in this Action 603 may comprise entering the mode of operation of the plurality of modes of operation. The plurality of modes of operation may comprise one of: a) continuous monitoring with the receiver, e.g., WUR, and b) discontinuous monitoring with the receiver, e.g., WUR., for example, duty-cycled WUR monitoring.

In some embodiments, the method may further comprise one or more of the following actions:

Sending 601 at least one of: a configuration comprising the condition, the first threshold and the second threshold. The second node 102 may be configured to perform this sending action 601, e.g. by means of a sending unit 1003 within the second node 102, configured to perform this action.

The sending in this Action 601 may be to the first node 101.

In some embodiments, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

Other units 1004 may be comprised in the second node 102.

The second node 102 may also be configured to communicate user data with a host application unit in a host computer QQ510, e.g., via another link such as QQ560.

In FIG. 10, optional units are indicated with dashed boxes.

The second node 102 may comprise an interface unit to facilitate communications between the second node 102 and other nodes or devices, e.g., the first node 101, the network node 110, the wireless device 130, the host computer QQ510, or any of the other nodes. In some particular examples, the interface may, for example, include a transceiver configured to transmit and receive radio signals over an air interface in accordance with a suitable standard.

The second node 102 may comprise an arrangement as shown in FIG. 10 or in FIG. QQ5.

Numbered examples related to embodiments herein:

Example 1. A method performed by a first node (101), the method being for handling a receiver at a wireless device (130), the first node (101) and the wireless device (130) operating in a wireless communications network (100), and the method comprising:
determining (502) whether or not a condition is met, and
initiating (503), based on a result of the determining (502), a procedure to wake-up the wireless device (130) by applying at least one of: a downlink signal to be used, and a receiver to, e.g., specifically, receive the downlink signal to wake-up the wireless device (130), e.g., a Wake-Up Receiver, WUR, at the wireless device (130).

Example 2. The method according to example 1, wherein the condition is one of:
one or more indications of coverage at a cell (120) comprised in the wireless communications network (100) wherein the wireless device (130) is located or receiving service,
a measurement of a signal received by the wireless device (130) being above or below a first threshold,
a length of a discontinuous reception cycle being above a second threshold,
an authorization for the wireless device (130) to use the receiver, e.g., WUR,
a first configuration of the wireless device (130) for the receiver, e.g., WUR being compatible with a second configuration for the receiver, e.g., WUR, at the cell (120) comprised in the wireless communications network (100) wherein the wireless device (130) is located or receiving service, e.g., at the time of the determining (502),
a use of the receiver, e.g., WUR, meeting a downlink latency requirement,
a first indication to use the receiver, e.g., WUR, being received from the wireless device (130),
a first capability to use the receiver, e.g., WUR, by the wireless device (130) matching a second capability by the cell (120) to use the receiver, e.g., WUR,
specific to the wireless device (130),
a first identity of the wireless device (130),
specific to the cell (120), and
a second identity of the cell (120).

Example 3. The method according to any of examples 1-2, further comprising:
obtaining (501) at least one of: a configuration comprising the condition, the first threshold and the second threshold.

Example 4. The method according to any of examples 1-3, wherein the applying (503) comprises entering a different state of a plurality of states defined for the wireless device (130), and wherein the condition defines a trigger to enter the state.

Example 5. The method according to example 4, wherein the condition is at least one of:
expiration of a timer, and
explicit indication from a network node (110) serving the wireless device (130).

Example 6. The method according to any of examples 1-5, wherein the first node (101) is one of a network node (110) serving the wireless device (130) and the wireless device (130).

Example 7. The method according to any of examples 1-5, wherein the first node (101) is the wireless device (130) and wherein the method further comprises:
sending (504) a second indication to a network node (110) serving the wireless device (130), the second indication indicating a result of the determination.

Example 8. The method according to any of examples 1-3, wherein the first node (101) is the network node (110), and wherein the applying (503) comprises entering a mode of operation of a plurality of modes of operation comprising one of: a) continuous monitoring with the receiver, e.g., WUR, and b) discontinuous monitoring with the receiver, e.g., WUR., for example duty-cycled WUR monitoring.

Example 9. The method according to example any of examples 1-8, wherein the condition is a coverage level in the cell (120).

Example 10. A method performed by a second node (102), the method being for handling a receiver at a wireless device (130), the second node (102) and the wireless device (130) operating in a wireless communications network (100), the method comprising:
receiving (602) a second indication from a first node (101) operating in the wireless communications network (100), the second indication indicating a result of a determination of whether or not a condition is met, and
initiating (603), based on the received second indication, a procedure to wake-up the wireless device (130) by applying at least one of: a downlink signal to be used, and a receiver to, e.g., specifically, receive the downlink signal to wake-up the wireless device (130), e.g., a Wake-Up Receiver, WUR, at the wireless device (130).

Example 11. The method according to example 10, wherein the condition is one of:
one or more indications of coverage at a cell (120) comprised in the wireless communications network (100) wherein the wireless device (130) is located or receiving service,
a measurement of a signal received by the wireless device (130) being above or below a first threshold,
a length of a discontinuous reception cycle being above a second threshold,
an authorization for the wireless device (130) to use the receiver, e.g., WUR,
a first configuration of the wireless device (130) for the receiver, e.g., WUR, being compatible with a second configuration for the receiver, e.g., WUR at the cell (120) comprised in the wireless communications network (100) wherein the wireless device (130) is located or receiving service,
a use of the receiver, e.g., WUR, meeting a downlink latency requirement,
a first indication to use the receiver, e.g., WUR, being received from the wireless device (130),
a first capability to use the receiver, e.g., WUR, by the wireless device (130) matching a second capability by the cell (120) to use the receiver, e.g., WUR,
specific to the wireless device (130),
a first identity of the wireless device (130),
specific to the wireless device (130), and
a second identity of the cell (120).

Example 12. The method according to any of examples 10-11, further comprising:
sending (601), to the first node (101), at least one of: a configuration comprising the condition, the first threshold and the second threshold.

Example 13. The method according to any of examples 10-12, wherein the applying (603) comprises entering a different state of a plurality of states defined for the wireless device (130), and wherein the condition defines a trigger to enter the state.

Example 14. The method according to example 13, wherein the condition is at least one of:
expiration of a timer, and
explicit indication from a network node (110) serving the wireless device (130).

Example 15. The method according to any of examples 10-14, wherein the first node (101) is one of a network node (110) serving the wireless device (130) and the wireless device (130).

Example 16. The method according to any of examples 10-12, wherein the first node (101) is the network node (110), and wherein the applying (603) comprises entering a mode of operation of a plurality of modes of operation comprising one of: a) continuous monitoring with the receiver, e.g., WUR, and b) discontinuous monitoring with the receiver, e.g., WUR, for example duty-cycled WUR monitoring.

Example 17. The method according to example any of examples 10-16, wherein the condition is a coverage level in the cell (120).

### Further Extensions And Variations

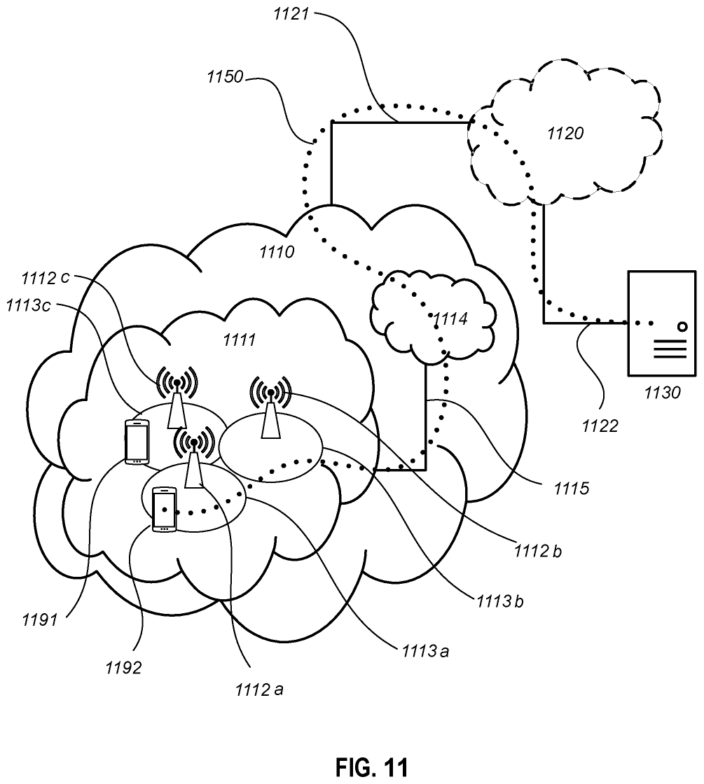

FIG. 11: Telecommunication network connected via an intermediate network to a host computer in accordance with some embodiments

With reference to FIG. 11, in accordance with an embodiment, a communication system includes telecommunication network 1110 such as the wireless communications network 100, for example, a 3GPP-type cellular network, which comprises access network 1111, such as a radio access network, and core network 1114. Access network 1111 comprises a plurality of network nodes such as the network node 110. For example, base stations 1112a, 1112b, 1112c, such as NBs, eNBs, gNBs or other types of wireless access points, each defining a corresponding coverage area 1113a, 1113b, 1113c. Each base station 1112a, 1112b, 1112c is connectable to core network 1114 over a wired or wireless connection 1115. A plurality of user equipments, such as the wireless device 130 are comprised in the wireless communications network 100. In FIG. 11, a first UE 1191 located in coverage area 1113c is configured to wirelessly connect to, or be paged by, the corresponding base station 1112c. A second UE 1192 in coverage area 1113a is wirelessly connectable to the corresponding base station 1112a. While a plurality of UEs 1191, 1192 are illustrated in this example, the disclosed embodiments are equally applicable to a situation where a sole UE is in the coverage area or where a sole UE is connecting to the corresponding base station 1112. Any of the UEs 1191, 1192 are examples of the wireless device 130.

Telecommunication network 1110 is itself connected to host computer 1130, which may be embodied in the hardware and/or software of a standalone server, a cloud-implemented server, a distributed server or as processing resources in a server farm. Host computer 1130 may be under the ownership or control of a service provider, or may be operated by the service provider or on behalf of the service provider. Connections 1121 and 1122 between telecommunication network 1110 and host computer 1130 may extend directly from core network 1114 to host computer 1130 or may go via an optional intermediate network 1120. Intermediate network 1120 may be one of, or a combination of more than one of, a public, private or hosted network; intermediate network 1120, if any, may be a backbone network or the Internet; in particular, intermediate network 1120 may comprise two or more sub-networks (not shown).

The communication system of FIG. 11 as a whole enables connectivity between the connected UEs 1191, 1192 and host computer 1130. The connectivity may be described as an over-the-top (OTT) connection 1150. Host computer 1130 and the connected UEs 1191, 1192 are configured to communicate data and/or signaling via OTT connection 1150, using access network 1111, core network 1114, any intermediate network 1120 and possible further infrastructure (not shown) as intermediaries. OTT connection 1150 may be transparent in the sense that the participating communication devices through which OTT connection 1150 passes are unaware of routing of uplink and downlink communications. For example, base station 1112 may not or need not be informed about the past routing of an incoming downlink communication with data originating from host computer 1130 to be forwarded (e.g., handed over) to a connected UE 1191. Similarly, base station 1112 need not be aware of the future routing of an outgoing uplink communication originating from the UE 1191 towards the host computer 1130.

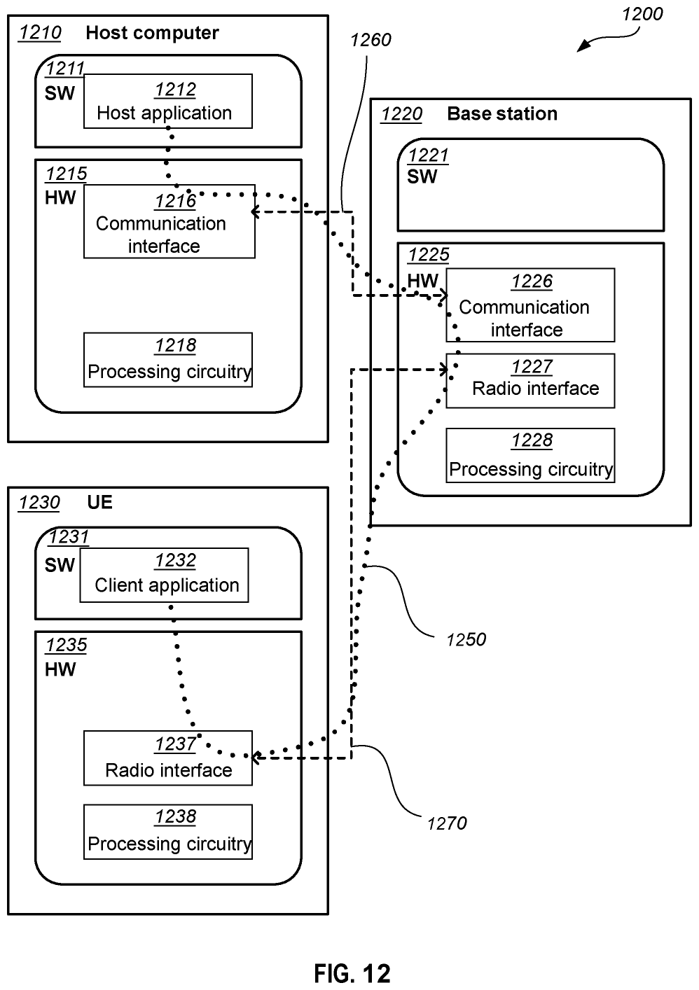

In relation to FIGS. 12, 13, 14, 15, and 16, which are described next, it may be understood that a UE is an example of the wireless device 130, and that any description provided for the UE equally applies to the wireless device 130. It may be also understood that the base station is an example of the network node 110, and that any description provided for the base station equally applies to the network node 110.

FIG. 12: Host computer communicating via a base station with a user equipment over a partially wireless connection in accordance with some embodiments

Example implementations, in accordance with an embodiment, of the wireless device 130, e.g., a UE, the network node 110, e.g., a base station and host computer discussed in the preceding paragraphs will now be described with reference to FIG. 12. In communication system 1200, such as the wireless communications network 100, host computer 1210 comprises hardware 1215 including communication interface 1216 configured to set up and maintain a wired or wireless connection with an interface of a different communication device of communication system 1200. Host computer 1210 further comprises processing circuitry 1218, which may have storage and/or processing capabilities. In particular, processing circuitry 1218 may comprise one or more programmable processors, application-specific integrated circuits, field programmable gate arrays or combinations of these (not shown) adapted to execute instructions. Host computer 1210 further comprises software 1211, which is stored in or accessible by host computer 1210 and executable by processing circuitry 1218. Software 1211 includes host application 1212. Host application 1212 may be operable to provide a service to a remote user, such as UE 1230 connecting via OTT connection 1250 terminating at UE 1230 and host computer 1210. In providing the service to the remote user, host application 1212 may provide user data which is transmitted using OTT connection 1250.

Communication system 1200 further includes the network node 110, exemplified in FIG. 12 as a base station 1220 provided in a telecommunication system and comprising hardware 1225 enabling it to communicate with host computer 1210 and with UE 1230. Hardware 1225 may include communication interface 1226 for setting up and maintaining a wired or wireless connection with an interface of a different communication device of communication system 1200, as well as radio interface 1227 for setting up and maintaining at least wireless connection 1270 with the wireless device 130, exemplified in FIG. 12 as a UE 1230 located in a coverage area (not shown in FIG. 12) served by base station 1220. Communication interface 1226 may be configured to facilitate connection 1260 to host computer 1210. Connection 1260 may be direct or it may pass through a core network (not shown in FIG. 12) of the telecommunication system and/or through one or more intermediate networks outside the telecommunication system. In the embodiment shown, hardware 1225 of base station 1220 further includes processing circuitry 1228, which may comprise one or more programmable processors, application-specific integrated circuits, field programmable gate arrays or combinations of these (not shown) adapted to execute instructions. Base station 1220 further has software 1221 stored internally or accessible via an external connection.

Communication system 1200 further includes UE 1230 already referred to. Its hardware 1235 may include radio interface 1237 configured to set up and maintain wireless connection 1270 with a base station serving a coverage area in which UE 1230 is currently located. Hardware 1235 of UE 1230 further includes processing circuitry 1238, which may comprise one or more programmable processors, application-specific integrated circuits, field programmable gate arrays or combinations of these (not shown) adapted to execute instructions. UE 1230 further comprises software 1231, which is stored in or accessible by UE 1230 and executable by processing circuitry 1238. Software 1231 includes client application 1232. Client application 1232 may be operable to provide a service to a human or non-human user via UE 1230, with the support of host computer 1210. In host computer 1210, an executing host application 1212 may communicate with the executing client application 1232 via OTT connection 1250 terminating at UE 1230 and host computer 1210. In providing the service to the user, client application 1232 may receive request data from host application 1212 and provide user data in response to the request data. OTT connection 1250 may transfer both the request data and the user data. Client application 1232 may interact with the user to generate the user data that it provides.

It is noted that host computer 1210, base station 1220 and UE 1230 illustrated in FIG. 12 may be similar or identical to host computer 1130, one of base stations 1112a, 1112b, 1112c and one of UEs 1191, 1192 of FIG. 11, respectively. This is to say, the inner workings of these entities may be as shown in FIG. 12 and independently, the surrounding network topology may be that of FIG. 11.

In FIG. 12, OTT connection 1250 has been drawn abstractly to illustrate the communication between host computer 1210 and UE 1230 via base station 1220, without explicit reference to any intermediary devices and the precise routing of messages via these devices. Network infrastructure may determine the routing, which it may be configured to hide from UE 1230 or from the service provider operating host computer 1210, or both. While OTT connection 1250 is active, the network infrastructure may further take decisions by which it dynamically changes the routing (e.g., on the basis of load balancing consideration or reconfiguration of the network).

Wireless connection 1270 between UE 1230 and base station 1220 is in accordance with the teachings of the embodiments described throughout this disclosure. One or more of the various embodiments improve the performance of OTT services provided to UE 1230 using OTT connection 1250, in which wireless connection 1270 forms the last segment. More precisely, the teachings of these embodiments may improve the latency, signalling overhead, and service interruption and thereby provide benefits such as reduced user waiting time, better responsiveness and extended battery lifetime.

A measurement procedure may be provided for the purpose of monitoring data rate, latency and other factors on which the one or more embodiments improve. There may further be an optional network functionality for reconfiguring OTT connection 1250 between host computer 1210 and UE 1230, in response to variations in the measurement results. The measurement procedure and/or the network functionality for reconfiguring OTT connection 1250 may be implemented in software 1211 and hardware 1215 of host computer 1210 or in software 1231 and hardware 1235 of UE 1230, or both. In embodiments, sensors (not shown) may be deployed in or in association with communication devices through which OTT connection 1250 passes; the sensors may participate in the measurement procedure by supplying values of the monitored quantities exemplified above, or supplying values of other physical quantities from which software 1211, 1231 may compute or estimate the monitored quantities. The reconfiguring of OTT connection 1250 may include message format, retransmission settings, preferred routing etc.; the reconfiguring need not affect base station 1220, and it may be unknown or imperceptible to base station 1220. Such procedures and functionalities may be known and practiced in the art. In certain embodiments, measurements may involve proprietary UE signaling facilitating host computer 1210's measurements of throughput, propagation times, latency and the like. The measurements may be implemented in that software 1211 and 1231 causes messages to be transmitted, in particular empty or ‘dummy’ messages, using OTT connection 1250 while it monitors propagation times, errors etc.

The first node 101 embodiments relate to FIG. 5, FIG. 7, FIG. 8 and FIGS. 11-16.

The first node 101 may also be configured to communicate user data with a host application unit in a host computer 1210, e.g., via another link such as 1260.

The first node 101 may comprise an interface unit to facilitate communications between the first node 101 and other nodes or devices, e.g., the second node 102, the network node 110, the wireless device 130, the host computer 1210, or any of the other nodes. In some particular examples, the interface may, for example, include a transceiver configured to transmit and receive radio signals over an air interface in accordance with a suitable standard.

The first node 101 may comprise an arrangement as shown in FIG. 9 or in FIG. 12.

The second node 102 embodiments relate to FIG. 6, FIG. 7, FIG. 8 and FIGS. 11-16.

The second node 102 may also be configured to communicate user data with a host application unit in a host computer 1210, e.g., via another link such as 1260.

The second node 102 may comprise an interface unit to facilitate communications between the second node 102 and other nodes or devices, e.g., the first node 101, the network node 110, the wireless device 130, the host computer 1210, or any of the other nodes. In some particular examples, the interface may, for example, include a transceiver configured to transmit and receive radio signals over an air interface in accordance with a suitable standard.

The second node 102 may comprise an arrangement as shown in FIG. 10 or in FIG. 12.

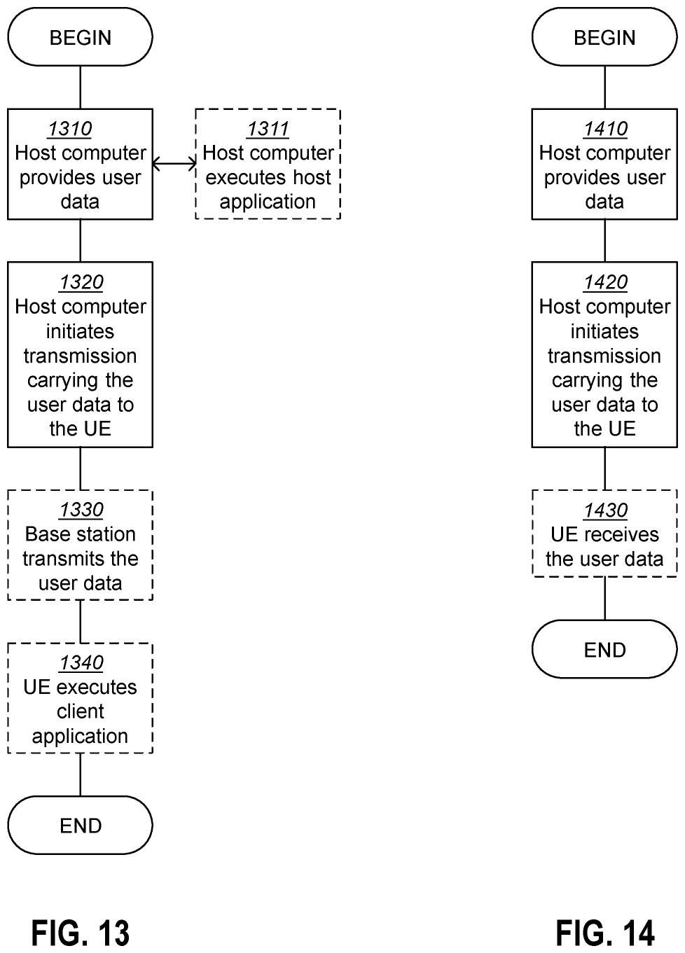

FIG. 13: Methods implemented in a communication system including a host computer, a base station and a user equipment in accordance with some embodiments

FIG. 13 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 13 will be included in this section. In step 1310, the host computer provides user data. In substep 1311 (which may be optional) of step 1310, the host computer provides the user data by executing a host application. In step 1320, the host computer initiates a transmission carrying the user data to the UE. In step 1330 (which may be optional), the base station transmits to the UE the user data which was carried in the transmission that the host computer initiated, in accordance with the teachings of the embodiments described throughout this disclosure. In step 1340 (which may also be optional), the UE executes a client application associated with the host application executed by the host computer.

FIG. 14: Methods implemented in a communication system including a host computer, a base station and a user equipment in accordance with some embodiments

FIG. 14 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 14 will be included in this section. In step 1410 of the method, the host computer provides user data. In an optional substep (not shown) the host computer provides the user data by executing a host application.

In step 1420, the host computer initiates a transmission carrying the user data to the UE. The transmission may pass via the base station, in accordance with the teachings of the embodiments described throughout this disclosure. In step 1430 (which may be optional), the UE receives the user data carried in the transmission.

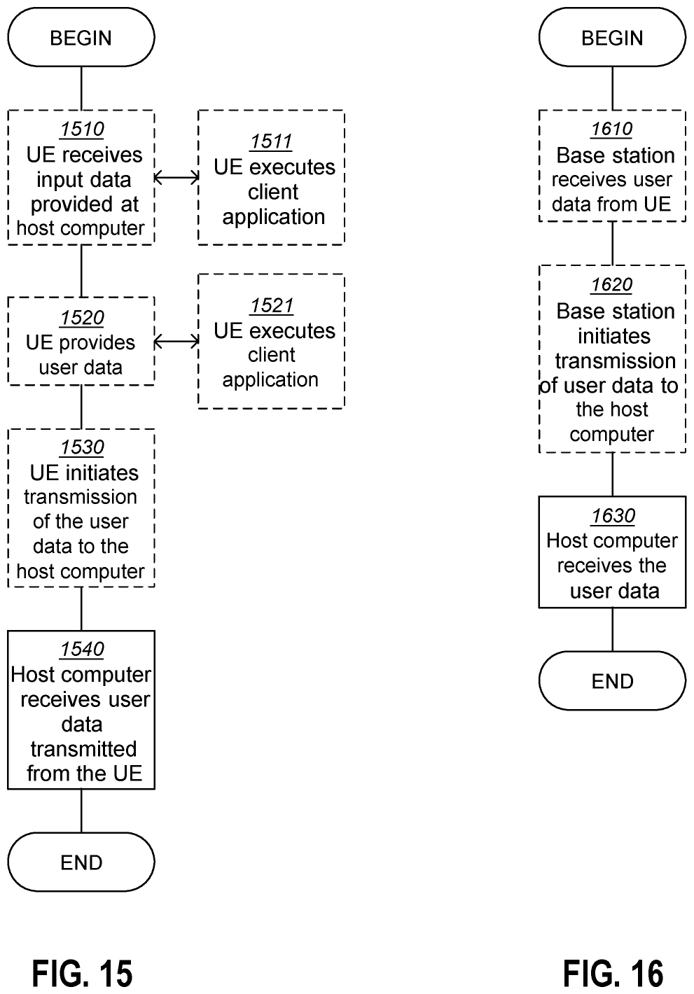

FIG. 15: Methods implemented in a communication system including a host computer, a base station and a user equipment in accordance with some embodiments

FIG. 15 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 15 will be included in this section. In step 1510 (which may be optional), the UE receives input data provided by the host computer. Additionally or alternatively, in step 1520, the UE provides user data. In substep 1521 (which may be optional) of step 1520, the UE provides the user data by executing a client application. In substep 1511 (which may be optional) of step 1510, the UE executes a client application which provides the user data in reaction to the received input data provided by the host computer. In providing the user data, the executed client application may further consider user input received from the user. Regardless of the specific manner in which the user data was provided, the UE initiates, in substep 1530 (which may be optional), transmission of the user data to the host computer. In step 1540 of the method, the host computer receives the user data transmitted from the UE, in accordance with the teachings of the embodiments described throughout this disclosure.

FIG. 16: Methods implemented in a communication system including a host computer, a base station and a user equipment in accordance with some embodiments

FIG. 16 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 16 will be included in this section. In step 1610 (which may be optional), in accordance with the teachings of the embodiments described throughout this disclosure, the base station receives user data from the UE. In step 1620 (which may be optional), the base station initiates transmission of the received user data to the host computer. In step 1630 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### Further Numbered Embodiments

1. A base station configured to communicate with a user equipment (UE), the base station comprising a radio interface and processing circuitry configured to perform one or more of the actions described herein as performed by the network node 110.

5. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform one or more of the actions described herein as performed by the network node 110.

6. The communication system of embodiment 5, further including the base station.

7. The communication system of embodiment 6, further including the UE, wherein the UE is configured to communicate with the base station.

8. The communication system of embodiment 7, wherein:
the processing circuitry of the host computer is configured to execute a host application, thereby providing the user data; and
the UE comprises processing circuitry configured to execute a client application associated with the host application.

11. A method implemented in a base station, comprising one or more of the actions described herein as performed by the network node 110.

15. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs one or more of the actions described herein as performed by the network node 110.

16. The method of embodiment 15, further comprising:
at the base station, transmitting the user data.

17. The method of embodiment 16, wherein the user data is provided at the host computer by executing a host application, the method further comprising:
at the UE, executing a client application associated with the host application.

21. A user equipment (UE) configured to communicate with a base station, the UE comprising a radio interface and processing circuitry configured to perform one or more of the actions described herein as performed by the wireless device 130.

25. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's processing circuitry configured to perform one or more of the actions described herein as performed by the wireless device 130.

26. The communication system of embodiment 25, further including the UE.

27. The communication system of embodiment 26, wherein the cellular network further includes a base station configured to communicate with the UE.

28. The communication system of embodiment 26 or 27, wherein:
the processing circuitry of the host computer is configured to execute a host application, thereby providing the user data; and
the UE's processing circuitry is configured to execute a client application associated with the host application.

31. A method implemented in a user equipment (UE), comprising one or more of the actions described herein as performed by the wireless device 130.

35. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs one or more of the actions described herein as performed by the wireless device 130.

36. The method of embodiment 35, further comprising:
at the UE, receiving the user data from the base station.

41. A user equipment (UE) configured to communicate with a base station, the UE comprising a radio interface and processing circuitry configured to perform one or more of the actions described herein as performed by the wireless device 130.

45. A communication system including a host computer comprising:
a communication interface configured to receive user data originating from a transmission from a user equipment (UE) to a base station,
wherein the UE comprises a radio interface and processing circuitry, the UE's processing circuitry configured to: perform one or more of the actions described herein as performed by the wireless device 130.

46. The communication system of embodiment 45, further including the UE.

47. The communication system of embodiment 46, further including the base station, wherein the base station comprises a radio interface configured to communicate with the UE and a communication interface configured to forward to the host computer the user data carried by a transmission from the UE to the base station.

48. The communication system of embodiment 46 or 47, wherein:
the processing circuitry of the host computer is configured to execute a host application; and
the UE's processing circuitry is configured to execute a client application associated with the host application, thereby providing the user data.

49. The communication system of embodiment 46 or 47, wherein:
the processing circuitry of the host computer is configured to execute a host application, thereby providing request data; and
the UE's processing circuitry is configured to execute a client application associated with the host application, thereby providing the user data in response to the request data.

51. A method implemented in a user equipment (UE), comprising one or more of the actions described herein as performed by the wireless device 130.

52. The method of embodiment 51, further comprising:
providing user data; and
forwarding the user data to a host computer via the transmission to the base station.

55. A method implemented in a communication system including a host computer, a base station and a user equipment (UE), the method comprising:
at the host computer, receiving user data transmitted to the base station from the UE, wherein the UE performs one or more of the actions described herein as performed by the wireless device 130.

56. The method of embodiment 55, further comprising:
at the UE, providing the user data to the base station.

57. The method of embodiment 56, further comprising:
at the UE, executing a client application, thereby providing the user data to be transmitted; and
at the host computer, executing a host application associated with the client application.

58. The method of embodiment 56, further comprising:
at the UE, executing a client application; and
at the UE, receiving input data to the client application, the input data being provided at the host computer by executing a host application associated with the client application,
wherein the user data to be transmitted is provided by the client application in response to the input data.

61. A base station configured to communicate with a user equipment (UE), the base station comprising a radio interface and processing circuitry configured to perform one or more of the actions described herein as performed by the network node 110.

65. A communication system including a host computer comprising a communication interface configured to receive user data originating from a transmission from a user equipment (UE) to a base station, wherein the base station comprises a radio interface and processing circuitry, the base station's processing circuitry configured to perform one or more of the actions described herein as performed by the network node 110.

66. The communication system of embodiment 65, further including the base station.

67. The communication system of embodiment 66, further including the UE, wherein the UE is configured to communicate with the base station.

68. The communication system of embodiment 67, wherein:
the processing circuitry of the host computer is configured to execute a host application;
the UE is configured to execute a client application associated with the host application, thereby providing the user data to be received by the host computer.

71. A method implemented in a base station, comprising one or more of the actions described herein as performed by the network node 110.

75. A method implemented in a communication system including a host computer, a base station and a user equipment (UE), the method comprising:
at the host computer, receiving, from the base station, user data originating from a transmission which the base station has received from the UE, wherein the UE performs one or more of the actions described herein as performed by the wireless device 130.

76. The method of embodiment 75, further comprising:
at the base station, receiving the user data from the UE.

77. The method of embodiment 76, further comprising:
at the base station, initiating a transmission of the received user data to the host computer.

1. A method performed by a first node for handling a receiver at a wireless device, the first node and the wireless device operating in a wireless communications network, the method comprising:
determining whether or not a condition is met, the condition being a measurement of a signal received by the wireless device being above or below a first threshold; and
initiating, based on a result of the determining, a procedure to wake-up the wireless device by applying at least one of: a downlink signal to be used, and a receiver to receive the downlink signal to wake-up the wireless device at the wireless device.

2. The method according to claim 1, wherein one or both:
the condition further comprises one of:
one or more indications of coverage at a cell comprised in the wireless communications network, wherein the wireless device is located or receiving service;
a length of a discontinuous reception cycle being above a second threshold;
an authorization for the wireless device to use the receiver;
a first configuration of the wireless device for the receiver being compatible with a second configuration for the receiver at the cell comprised in the wireless communications network, wherein the wireless device is located or receiving service;
a use of the receiver meeting a downlink latency requirement;
a first indication to use the receiver being received from the wireless device;
a first capability to use the receiver by the wireless device matching a second capability by the cell to use the receiver; and
the condition is one of:
specific to the wireless device;
a first identity of the wireless device;
specific to the cell; and
a second identity of the cell.

3. The method according to claim 2, further comprising:
obtaining at least one of: a configuration comprising the condition, the first threshold and the second threshold.

4. The method according to claim 1, wherein the applying comprises entering a different state of a plurality of states defined for the wireless device, and wherein the condition defines a trigger to enter the state.

5. The method according to claim 4, wherein the condition is at least one of:
expiration of a timer; and
explicit indication from a network node serving the wireless device.

6. The method according to claim 1, wherein the first node is one of a network node serving the wireless device and the wireless device.

7. The method according to claim 1, wherein the first node is the wireless device and wherein the method further comprises:
sending a second indication to a second node operating in the wireless communications network, the second indication indicating a result of the determination.

8. The method according to claim 1, wherein the first node is a network node, and wherein the applying comprises entering a mode of operation of a plurality of modes of operation comprising one of: a) continuous monitoring with the receiver and b) discontinuous monitoring with the receiver.

9. The method according to claim 1, wherein the condition is a coverage level in a cell comprised in the wireless communications network wherein the wireless device is located or receiving service.

10. The method according to claim 1, wherein the receiver is a Wake-Up Receiver, WUR.

11. A method performed by a second node for handling a receiver at a wireless device, the second node and the wireless device operating in a wireless communications network, the method comprising:
receiving a second indication from a first node operating in the wireless communications network, the second indication indicating a result of a determination of whether or not a condition is met, the condition being a measurement of a signal received by the wireless device being above or below a first threshold; and
initiating, based on the received second indication, a procedure to wake-up the wireless device by applying at least one of: a downlink signal to be used, and a receiver to receive the downlink signal to wake-up the wireless device at the wireless device.

12. The method according to claim 11, wherein one or both:
the condition further comprises one of:
one or more indications of coverage at a cell comprised in the wireless communications network, wherein the wireless device is located or receiving service;
a length of a discontinuous reception cycle being above a second threshold;
an authorization for the wireless device to use the receiver;
a first configuration of the wireless device for the receiver being compatible with a second configuration for the receiver at the cell comprised in the wireless communications network, wherein the wireless device is located or receiving service;
a use of the receiver meeting a downlink latency requirement;
a first indication to use the receiver being received from the wireless device;
a first capability to use the receiver by the wireless device matching a second capability by the cell to use the receiver; and
the condition is one of:
specific to the wireless device;
a first identity of the wireless device;
specific to the cell; and
a second identity of the cell.

13. The method according to claim 11, further comprising:
sending, to the first node, at least one of: a configuration comprising the condition, the first threshold and the second threshold.

14. The method according to claim 11, wherein the applying comprises entering a different state of a plurality of states defined for the wireless device, and wherein the condition defines a trigger to enter the state.

15. The method according to claim 14, wherein the condition is at least one of:
expiration of a timer; and
explicit indication from a network node serving the wireless device.

16. The method according to claim 11, wherein the first node is one of a network node serving the wireless device and the wireless device.

17. The method according to claim 11, wherein the first node is the network node, and wherein the applying comprises entering a mode of operation of a plurality of modes of operation comprising one of: a) continuous monitoring with the receiver and b) discontinuous monitoring with the receiver.

18. The method according to claim 11, wherein the condition is a coverage level in a cell comprised in the wireless communications network wherein the wireless device is located or receiving service.

19. The method according to claim 11, wherein the receiver is a Wake-Up Receiver, WUR.

20. A first node, for handling a receiver at a wireless device, the first node and the wireless device being configured to operate in a wireless communications network, the first node being further configured to:
determine whether or not a condition is met, wherein the condition is configured to be a measurement of a signal configured to be received by the wireless device being above or below a first threshold; and
initiate, based on a result of the determining, a procedure to wake-up the wireless device by applying at least one of: a downlink signal to be used, and a receiver to receive the downlink signal to wake-up the wireless device at the wireless device.

21. The first node according to claim 20, wherein one or both:
the condition further comprises one of:
one or more indications of coverage at a cell comprised in the wireless communications network, wherein the wireless device is located or receiving service;
a length of a discontinuous reception cycle being above a second threshold;
an authorization for the wireless device to use the receiver;
a first configuration of the wireless device for the receiver being compatible with a second configuration for the receiver at the cell comprised in the wireless communications network, wherein the wireless device is located or receiving service;
a use of the receiver meeting a downlink latency requirement;
a first indication to use the receiver being received from the wireless device;
a first capability to use the receiver by the wireless device matching a second capability by the cell to use the receiver; and
the condition is configured to be one of:
specific to the wireless device;
a first identity of the wireless device;
specific to the cell; and
a second identity of the cell.

22. The first node according to claim 21, being further configured to:
obtain at least one of: a configuration configured to be comprising the condition, the first threshold and the second threshold.

23. The first node according to claim 20, wherein the applying is configured to comprise entering a different state of a plurality of states configured to be defined for the wireless device, and wherein the condition is configured to define a trigger to enter the state.

24.-29. (canceled)

30. A second node, for handling a receiver at a wireless device, the second node and the wireless device being configured to operate in a wireless communications network, the second node being further configured to:
receive a second indication from a first node configured to operate in the wireless communications network, the second indication being configured to indicate a result of a determination of whether or not a condition is met, wherein the condition is configured to be a measurement of a signal configured to be received by the wireless device being above or below a first threshold; and
initiate, based on the second indication configured to be received, a procedure to wake-up the wireless device by applying at least one of: a downlink signal to be used, and a receiver configured to receive the downlink signal to wake-up the wireless device at the wireless device.

31. The second node according to claim 30, wherein one or both:
the condition further comprises one of:
one or more indications of coverage at a cell comprised in the wireless communications network, wherein the wireless device is located or receiving service;
a length of a discontinuous reception cycle being above a second threshold;
an authorization for the wireless device to use the receiver;
a first configuration of the wireless device for the receiver being compatible with a second configuration for the receiver at the cell comprised in the wireless communications network, wherein the wireless device is located or receiving service;
a use of the receiver meeting a downlink latency requirement;
a first indication to use the receiver being received from the wireless device;
a first capability to use the receiver by the wireless device matching a second capability by the cell to use the receiver; and
the condition is configured to be one of:
specific to the wireless device;
a first identity of the wireless device;
specific to the cell; and
a second identity of the cell.

32. The second node according to claim 30, further configured to:
send, to the first node, at least one of: a configuration configured to comprise the condition, the first threshold and the second threshold.

33.-38. (canceled)
